(19) United States
(12) Patent Application Publication
(10) Pub. No.: US 2012/0192119 A1
(43) Pub. Date: Jul. 26, 2012

(54) USB HID DEVICE ABSTRACTION FOR HDTP USER INTERFACES

(75) Inventor: Vadim ZALIVA, Freemont, CA (US)

(73) Assignee: Lester F. LUDWIG, Belmont, CA (US)

(21) Appl. No.: 13/356,578

(22) Filed: Jan. 23, 2012

Related U.S. Application Data
(60) Provisional application No. 61/435,401, filed on Jan. 24, 2011.

(51) Int. Cl. G06F 3/033

(52) U.S. Cl. 715/863

(57) ABSTRACT

A method for implementing USB communications providing user interface measurement and detection of at least one gesture and one angle of finger position for a touch-based user interface is disclosed. The method comprises receiving real-time tactile-image information from a tactile sensor array; processing the tactile-image information to detect and measure the variation of one angle of a finger position and to detect at least one gesture producing at least one of a parameter value responsive to the variation in the finger angle and a symbol responsive to a detected gesture. These are mapped to a Universal Serial Bus (USB) Human Interface Device message which is transmitted to a host device over USB hardware for use by an application executing on the host device. The method provides for the incorporation of various configurations, tactical grammars, use with a touch screen, and numerous other features.

### CROSS-REFERENCE TO RELATED APPLICATIONS

Pursuant to 35 U.S.C. §119(e), this application claims benefit of priority from Provisional U.S. Patent application Ser. No. 61/435,401, filed Jan. 24, 2011, the contents of which are incorporated by reference.

### COPYRIGHT & TRADEMARK NOTICES

A portion of the disclosure of this patent document may contain material, which is subject to copyright protection. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### BACKGROUND OF THE INVENTION

The invention relates to user interfaces providing an additional number of simultaneously-adjustable interactively-controlled discrete (clicks, taps, discrete gestures) and pseudo-continuous (downward pressure, roll, pitch, yaw, multi-touch geometric measurements, continuous gestures, etc.) user-adjustable settings and parameters, and in particular to the use of the USB HID device abstraction for interfacing such user interfaces to applications, and further how these can be used in applications.

The present invention provides extensions and improvements to the user interface parameter signals provided by the High Dimensional Touchpad (HTPD), for example as taught in U.S. Pat. No. 6,570,078 and pending U.S. patent application Ser. Nos. 11/761,978 and 12/418,605, as well as other systems and methods that can incorporate similar or related technologies.

The extensions and improvements provided by the present invention include the use of the USB HID device abstraction for interfacing such user interfaces to applications.

By way of introduction, touch screens implementing tactile sensor arrays have recently received tremendous attention with the addition multi-touch sensing, metaphors, and gestures. After an initial commercial appearance in the products of FingerWorks, such advanced touch screen technologies have received great commercial success from their defining role in the iPhone and subsequent adaptations in PDAs and other types of cell phones and hand-held devices. Despite this popular notoriety and the many associated patent filings, tactile array sensors implemented as transparent touchscreens were in fact taught in the 1999 filings of issued U.S. Pat. No. 6,570,078 and pending U.S. patent application Ser. No. 11/761,978.

Despite the many popular touch interfaces and gestures, there remains a wide range of additional control capabilities that can yet be provided by further enhanced user interface technologies. A number of enhanced touch user interface features are described in U.S. Pat. No. 6,570,078, pending U.S. patent application Ser. Nos. 11/761,978, 12/418,605, 12/502,230, 12/541,948, and related pending US patent applications. These patents and patent applications also address popular contemporary gesture and touch features. The enhanced user interface features taught in these patents and patent applications, together with popular contemporary gesture and touch features, can be rendered by the “High Definition Touch Pad” (HDTP) technology taught in those patents and patent applications. Implementations of the HTDP provide advanced multi-touch capabilities far more sophisticated that those popularized by FingerWorks, Apple, NYU, Microsoft, Gesturetek, and others.

### SUMMARY OF THE INVENTION

In an embodiment, the invention provides a user interface providing an additional number of simultaneously-adjustable interactively-controlled discrete (clicks, taps, discrete gestures) and pseudo-continuous (downward pressure, roll, pitch, yaw, multi-touch geometric measurements, continuous gestures, etc.) user-adjustable settings and parameters, this user interface further provided with a USB HID device abstraction for interfacing such user interfaces to applications.

In a first embodiment, a USB HID device abstraction is employed to connect a computer or other device with an HDTP sensor that is connected to the computer via a USB interface. Here the HDTP signal processing and HDTP gesture detection are implemented on the computer or other device.

In another embodiment, a USB HID device abstraction is employed to connect a computer or other device with an HDTP sensor and one or more associated processor(s) which in turn is/are connected to the computer via a USB interface. Here the HDTP signal processing and HDTP gesture detection are implemented on the one or more processor(s) associated with HDTP sensor

In another embodiment, a USB HID device abstraction is used as a software interface even though no USB port is actually used.

In another embodiment, a USB HID device abstraction is used to provide HDTP user interface signals to one or more applications (as well as the operating system or windowing system in some implementations).

In another embodiment, the HDTP to interface one or more applications executing on a computer or other device through use of the USB HID device class.

In another embodiment, the USB HID device class provides an open interface useful for both traditional computer pointing devices such as the standard computer mouse as well as other user interface devices such as game controllers and the Logitech 3DConnexion SpaceNavigator™.

In an embodiment, the HDTP uses one or more Report Descriptor Item(s) for creating HID protocols.

In an embodiment, the HDTP use only one set of Report Descriptor Item(s) to provide routing and mapping information for HDTP parameters and/or gestures.

In another embodiment, the HDTP uses a plurality of Report Descriptor Item(s) to provide routing and mapping information for HDTP parameters and/or gestures.

In another embodiment, the HDTP has only a single configuration and thus uses only one Configuration Descriptor.

In another embodiment, the HDTP has a plurality of configurations and thus provide a plurality of Configuration Descriptors.

In another embodiment, the HDTP includes an Interface Descriptor with class field used to define the HDTP as a HID class device.

In another embodiment, the HDTP includes boot device protocols and one or more associated HID subclasses.

In an embodiment, the HDTP includes at least host-polled communications via the “Control Pipe” formalism.

In another embodiment, the HDTP includes asynchronous communications via the “Interrupt Pipe” formalism.

In another embodiment, the HDTP includes mapping of a gesture event (symbol) stream and possible associated parameter(s) stream to corresponding USB HID messages.

In another embodiment, the USB HID messages associated with the HDTP comprise “standard” or “pseudo-standard” types of USB messages and/or other types of USB message channels.

In an embodiment, the invention comprises a method for implementing USB communications for a touch-based user interface providing user interface measurement and detection of at least one gesture and one angle of finger position, the method comprising:
receiving real-time tactile-image information from a tactile sensor array;
processing the real-time tactile-image information to detect and measure the variation one angle of finger position and to detect at least one gesture, the processing further producing at least one of a parameter value responsive to the change in finger angle and a symbol responsive to a detected gesture;
mapping the at least one parameter value and symbol to a Universal Serial Bus (USB) Human Interface Device) HID message, and
transmitting the HID message to a host device over USB hardware,
   wherein the at least one parameter value and symbol is carried by the USB HID message for use by an application executing on the host device.

In an embodiment, the method further provides for the host device to comprise a desktop computer.

In an embodiment, the method further provides for the tactile sensor array to comprise a touchscreen.

In an embodiment, the method further provides for the finger angle to comprise a yaw angle.

In an embodiment, the method further provides for the finger angle to comprise a roll angle.

In an embodiment, the method further provides for the finger angle to comprise a pitch angle.

In an embodiment, the method further provides for the gesture to comprise a finger flick.

In an embodiment, the method further provides for the processing to also produce at least one parameter associated with the gesture, the parameter comprising a value responsive to the real-time tactile-image information.

In an embodiment, the method further provides for at least one parameter associated with the gesture to be carried by the USB HID message.

In an embodiment, the method further provides for at least one of the processing, mapping, and transmitting to comprise a HID Report Descriptor.

In an embodiment, the method further provides for the HID Report Descriptor to be transmitted to the host device.

In an embodiment, the method further provides for at least one of the processing, mapping, and transmitting to comprise at least one HID Physical Descriptor.

In an embodiment, the method further provides for at least one of the processing, mapping, and transmitting to comprise at least one HID Endpoint Descriptor.

In an embodiment, the method further provides for at least one of the processing, mapping, and transmitting to comprise at least one HID Configuration Descriptor.

In an embodiment, the method further provides for the processing further recognizes a plurality of gestures.

In an embodiment, the method further provides for the processing of a selected plurality from of the gestures within the plurality of gestures also to produce at least one parameter, said parameter comprising a value responsive to real-time tactile-image information, said parameter associated with each gesture in the selected plurality.

In an embodiment, the method further provides for the value of at least one parameter associated with each gesture in the selected plurality to be carried by the USB HID message.

In an embodiment, the method further provides for a sequence of gestures to be presented to further processing to create a meta-gesture.

In an embodiment, the method further provides for the further processing to employ a tactile grammar.

20. In an embodiment, the method further provides for information representing the meta-gesture to be carried by the USB HID message.

### BRIEF DESCRIPTION OF THE DRAWINGS

The above and other aspects, features and advantages of the present invention will become more apparent upon consideration of the following description of preferred embodiments taken in conjunction with the accompanying drawing and figures.

FIGS. 1a-1g depict a number of arrangements and embodiments employing the HDTP technology.

FIGS. 2a-2e and FIGS. 3a-3b depict various integrations of an HDTP into the back of a conventional computer mouse as taught in U.S. Pat. No. 7,557,797 and in pending U.S. patent application Ser. No. 12/619,678.

FIG. 4 illustrates the side view of a finger lightly touching the surface of a tactile sensor array.

FIG. 5a is a graphical representation of a tactile image produced by contact of a human finger on a tactile sensor array. FIG. 5b provides a graphical representation of a tactile image produced by contact with multiple human fingers on a tactile sensor array.

FIG. 6 depicts a signal flow in an HDTP implementation.

FIG. 7 depicts a pressure sensor array arrangement.

FIG. 8 depicts a popularly accepted view of a typical cell phone or PDA capacitive proximity sensor implementation.

FIG. 9 depicts an implementation of a multiplexed LED array acting as a reflective optical proximity sensing array.

FIGS. 10a-10c depict camera implementations for direct viewing of at least portions of the human hand, wherein the camera image array is employed as an HDTP tactile sensor array.

FIG. 11 depicts an embodiment of an arrangement comprising a video camera capturing the image of the contact of parts of the hand with a transparent or translucent surface.

FIGS. 12a-12b depict an implementation of an arrangement comprising a video camera capturing the image of a deformable material whose image varies according to applied pressure.

FIG. 13 depicts an implementation of an optical or acoustic diffraction or absorption arrangement that can be used for contact or pressure sensing of tactile contact.

FIG. 14 shows a finger image wherein rather than a smooth gradient in pressure or proximity values there is radical variation due to non-uniformities in offset and scaling terms among the sensors.

FIG. 15 show a sensor-by-sensor compensation arrangement.

FIG. 16 (adapted from http://labs.moto.com/diy-touchscreen-analysis/) depicts the comparative performance of a group of contemporary handheld devices wherein straight lines were entered using the surface of the respective touchscreens.

FIGS. 17a-17f illustrate the six independently adjustable degrees of freedom of touch from a single finger that can be simultaneously measured by the HDTP technology.

FIG. 18 suggests general ways in which two or more of these independently adjustable degrees of freedom adjusted at once.

FIG. 19 demonstrates a few two-finger multi-touch postures and/or gestures from the many that can be readily recognized by HTDP technology.

FIG. 20 illustrates the pressure profiles for a number of example hand contacts with a pressure-sensor array.

FIG. 21 depicts one of a wide range of tactile sensor images that can be measured by using more of the human hand

FIGS. 22a-22c depict various approaches to the handling of compound posture data images.

FIG. 23 illustrates correcting tilt coordinates with knowledge of the measured yaw angle, compensating for the expected tilt range variation as a function of measured yaw angle, and matching the user experience of tilt with a selected metaphor interpretation.

FIG. 24a depicts an embodiment wherein the raw tilt measurement is used to make corrections to the geometric center measurement under at least conditions of varying the tilt of the finger. FIG. 24b depicts an embodiment for yaw angle compensation in systems and situations wherein the yaw measurement is sufficiently affected by tilting of the finger.

FIG. 25 shows an arrangement wherein raw measurements of the six quantities of FIGS. 17a-17f, together with multitouch parsing capabilities and shape recognition for distinguishing contact with various parts of the hand and the touchpad can be used to create a rich information flux of parameters, rates, and symbols.

FIG. 26 shows an approach for incorporating posture recognition, gesture recognition, state machines, and parsers to create an even richer human/machine tactile interface system capable of incorporating syntax and grammars.

FIGS. 27a-27d depict operations acting on various parameters, rates, and symbols to produce other parameters, rates, and symbols, including operations such as sample/hold, interpretation, context, etc.

FIG. 28 depicts a user interface input arrangement incorporating one or more HDTPs that provides user interface input event and quantity routing.

FIGS. 29a-29c depict methods for interfacing the HDTP with a browser.

FIG. 30a depicts a user-measurement training procedure wherein a user is prompted to touch the tactile sensor array in a number of different positions. FIG. 30b depicts additional postures for use in a measurement training procedure for embodiments or cases wherein a particular user does not provide sufficient variation in image shape the training. FIG. 30c depicts boundary-tracing trajectories for use in a measurement training procedure.

FIG. 31 depicts an HDTP signal flow chain for an HDTP realization implementing multi-touch, shape and constellation (compound shape) recognition, and other features.

FIG. 32 shows an adaptation of the arrangement of FIG. 31 wherein each raw parameter vector is provided to additional parameter refinement processing to produce a corresponding refined parameter vector.

FIG. 33 depicts an arrangement wherein the additional parameter refinement processing depicted in FIG. 32 comprises two or more internal parameter refinement stages that can be interconnected as advantageous.

FIG. 34 (adapted from Universal Serial Bus (USB) Device Class Definition for Human Interface Devices (HID) Version 1.11) depicts a basic architecture for USB HID device software executing on a peripheral device and its interfacing, via USB hardware, with USB HID host driver software hosted the hosting computer or other device.

FIGS. 35-37 depict embodiments providing HDTP technologies with a HID device abstraction for interfacing to applications.

FIG. 38a (adapted from Universal Serial Bus (USB) Device Class Definition for Human Interface Devices (HID) Version 1.11) depicts the HID device class comprising a descriptor called the “HID descriptor” which in turn consists of a “Report Descriptor” and a “Physical Descriptor.”

FIG. 38b (adapted from combining several figures from Universal Serial Bus (USB) Device Class Definition for Human Interface Devices (HID) Version 1.11) depicts the HID class “HID Descriptor” and “Endpoint descriptor” together comprised by an “Interface Descriptor” that is in turn comprised by a “Configuration Descriptor” within the “Device Descriptor,” and (peer to the Device Descriptor) a “String Descriptor.”

FIG. 38c (adapted from Universal Serial Bus (USB) Device Class Definition for Human Interface Devices (HID) Version 1.11) depicts how an HID class device appears to the parser within the HID driver.

FIG. 38d (adapted from Universal Serial Bus (USB) Device Class Definition for Human Interface Devices (HID) Version 1.11) depicts how an HID class driver communicates with an HID class device using either host-polled communications via a “Control Pipe” formalism or an optional lower-latency asynchronous “Interrupt Pipe.”

FIG. 39a depicts a summary representation of the single-finger gesture recognition and associated parameter production capabilities provided for by the invention.

FIG. 39b depicts a summary representation of the multi-finger constellation gesture recognition and associated parameter production capabilities provided for by the invention.

FIG. 40 depicts a summary representation of the gesture-sequence recognition/processing and associated parameter production capabilities provided for by the invention.

FIG. 41 depicts a summary representation of the compound gesture recognition/processing and associated parameter production capabilities provided for by the invention.

FIG. 42 depicts a representation illustrating the mapping of a gesture event (symbol) stream and possible associated parameter(s) stream to corresponding USB HID messages.

The USB HID messages may comprise “standard” or “pseudo-standard” types of USB messages and/or other types of USB message channels.

FIG. 43 depicts a representation illustrating an example mapping of a gesture event (symbol) stream and possible associated parameter(s) stream to corresponding “Standard” USB HID messages and additional USB HID messages (this merely one of many possibilities wherein HDTP USB HID messages comprise “standard” or “pseudo-standard” types of USB messages and/or other types of USB message channels).

FIG. 44a depicts the single-finger parameter channel arrangements depicted in FIGS. 39a, 42, and 43 mapped on to the arrangement depicted in FIG. 37.

FIG. 44b depicts the single-finger parameter and gesture event arrangements depicted in FIGS. 39a, 42, and 43 mapped on to the arrangement depicted in FIG. 37.

FIG. 44c depicts the single-finger parameter, gesture event, and associated gesture parameter arrangements depicted in FIGS. 39a, 42, and 43 mapped on to the arrangement depicted in FIG. 37.

FIG. 45a depicts the multi-finger parameter channel arrangements depicted in FIGS. 39b, 42, and 43 mapped on to the arrangement depicted in FIG. 37.

FIG. 45b depicts the multi-finger parameter and gesture event arrangements depicted in FIGS. 39b, 42, and 43 mapped on to the arrangement depicted in FIG. 37.

FIG. 45c depicts the multi-finger parameter, gesture event, and associated gesture parameter arrangements depicted in FIGS. 39b, 42, and 43 mapped on to the arrangement depicted in FIG. 37.

### DETAILED DESCRIPTION

In the following detailed description, reference is made to the accompanying drawing figures which form a part hereof, and which show by way of illustration specific embodiments of the invention. It is to be understood by those of ordinary skill in this technological field that other embodiments can be utilized, and structural, electrical, as well as procedural changes can be made without departing from the scope of the present invention. Wherever possible, the same element reference numbers will be used throughout the drawings to refer to the same or similar parts.

Despite the many popular touch interfaces and gestures in contemporary information appliances and computers, there remains a wide range of additional control capabilities that can yet be provided by further enhanced user interface technologies. A number of enhanced touch user interface features are described in U.S. Pat. No. 6,570,078, pending U.S. patent application Ser. Nos. 11/761,978, 12/418,605, 12/502,230, 12/541,948, and related pending US patent applications. These patents and patent applications also address popular contemporary gesture and touch features. The enhanced user interface features taught in these patents and patent applications, together with popular contemporary gesture and touch features, can be rendered by the “High Definition Touch Pad” (HDTP) technology taught in those patents and patent applications.

The present patent application addresses additional technologies for feature and performance improvements of HDTP technologies. Specifically, this patent application providing and/or implementing HDTP technologies with a USB HID device abstraction for interfacing such user interfaces to applications.

### Overview of HDTP User Interface Technology

Before providing details specific to the present invention, some embodiments of HDTP technology are provided. This will be followed by a summarizing overview of HDTP technology.

Exemplary Embodiments Employing a Touchpad and Touchscreen Form of a HDTP

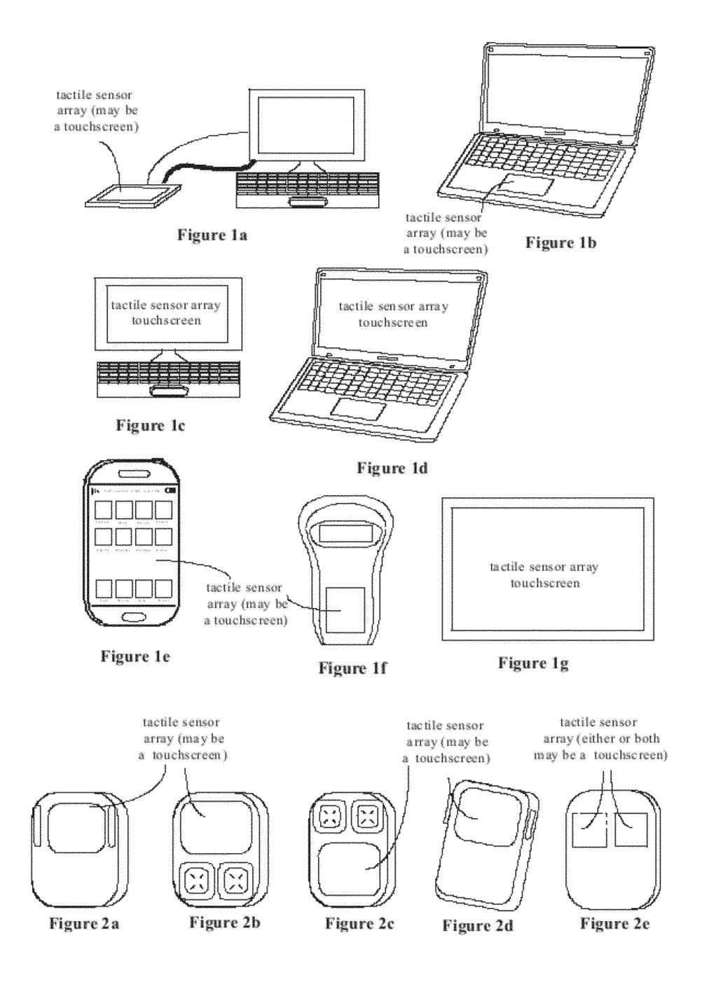

FIGS. 1a-1g and 2a-2e depict a number of arrangements and embodiments employing the HDTP technology. FIG. 1a illustrates an HDTP as a peripheral that can be used with a desktop computer (shown) or laptop) not shown). FIG. 1b shows depicts an HDTP integrated into a laptop in place of the traditional touchpad pointing device. In FIGS. 1a-1b the HDTP tactile sensor can be a stand-alone component or can be integrated over a display so as to form a touchscreen. FIG. 1c depicts an HDTP integrated into a desktop computer display so as to form a touchscreen. FIG. 1d shows the HDTP integrated into a laptop computer display so as to form a touchscreen.

FIG. 1e depicts an HDTP integrated into a cell phone, smartphone, PDA, or other hand-held consumer device. FIG. 1f shows an HDTP integrated into a test instrument, portable service-tracking device, portable service-entry device, field instrument, or other hand-held industrial device. In FIGS. 1e-1f the HDTP tactile sensor can be a stand-alone component or can be integrated over a display so as to form a touchscreen.

FIG. 1g depicts an HDTP touchscreen configuration that can be used in a tablet computer, wall-mount computer monitor, digital television, video conferencing screen, kiosk, etc.

In at least the arrangements of FIGS. 1a, 1c, 1d, and 1g, or other sufficiently large tactile sensor implementation of the HDTP, more than one hand can be used an individually recognized as such.

Embodiments Incorporating the HDTP into a Traditional or Contemporary Generation Mouse

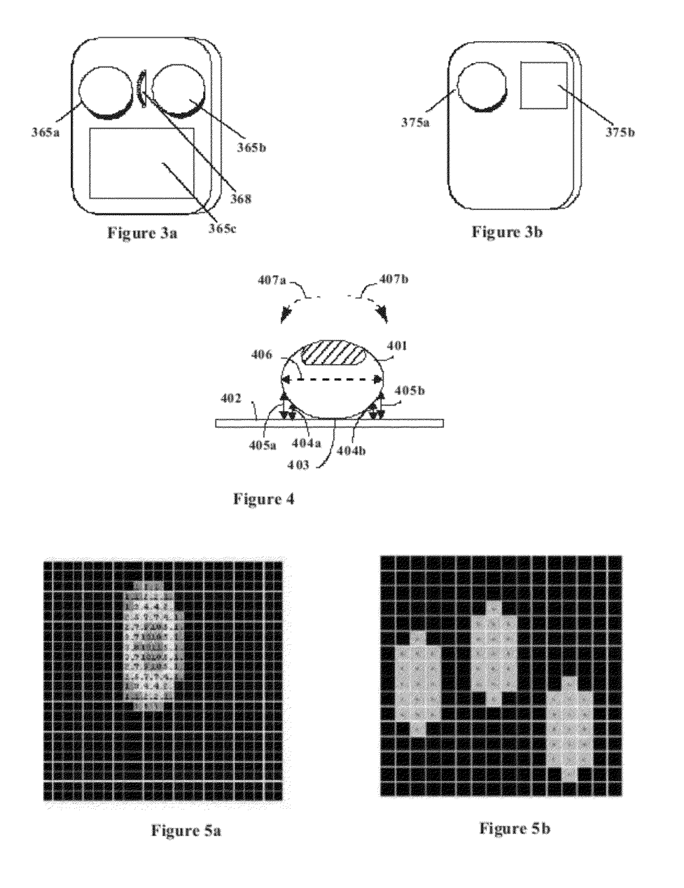

FIGS. 2a-2e and FIGS. 3a-3b depict various integrations of an HDTP into the back of a conventional computer mouse. Any of these arrangements can employ a connecting cable, or the device can be wireless.

In the integrations depicted in FIGS. 2a-2d the HDTP tactile sensor can be a stand-alone component or can be integrated over a display so as to form a touchscreen. Such configurations have very recently become popularized by the product release of Apple “Magic Mouse™” although such combinations of a mouse with a tactile sensor array on its back responsive to multitouch and gestures were taught earlier in pending U.S. patent application Ser. No. 12/619,678 (priority date Feb. 12, 2004) entitled “User Interface Mouse with Touchpad Responsive to Gestures and Multi-Touch.”

In another embodiment taught in the specification of issued U.S. Pat. No. 7,557,797 and associated pending continuation applications more than two touchpads can be included in the advance mouse embodiment, for example as suggested in the arrangement of FIG. 2e. As with the arrangements of FIGS. 2a-2d, one or more of the plurality of HDTP tactile sensors or exposed sensor areas of arrangements such as that of FIG. 2e can be integrated over a display so as to form a touchscreen. Other advanced mouse arrangements include the integrated trackball/touchpad/mouse combinations of FIGS. 3a-3b taught in U.S. Pat. No. 7,557,797.

### Overview of HDTP User Interface Technology

The information in this section provides an overview of HDTP user interface technology as described in U.S. Pat. No. 6,570,078, pending U.S. patent application Ser. Nos. 11/761,978, 12/418,605, 12/502,230, 12/541,948, and related pending US patent applications.

In an embodiment, a touchpad used as a pointing and data entry device can comprise an array of sensors. The array of sensors is used to create a tactile image of a type associated with the type of sensor and method of contact by the human hand.

In one embodiment, the individual sensors in the sensor array are pressure sensors and a direct pressure-sensing tactile image is generated by the sensor array.

In another embodiment, the individual sensors in the sensor array are proximity sensors and a direct proximity tactile image is generated by the sensor array. Since the contacting surfaces of the finger or hand tissue contacting a surface typically increasingly deforms as pressure is applied, the sensor array comprised of proximity sensors also provides an indirect pressure-sensing tactile image.

In another embodiment, the individual sensors in the sensor array can be optical sensors. In one variation of this, an optical image is generated and an indirect proximity tactile image is generated by the sensor array. In another variation, the optical image can be observed through a transparent or translucent rigid material and, as the contacting surfaces of the finger or hand tissue contacting a surface typically increasingly deforms as pressure is applied, the optical sensor array also provides an indirect pressure-sensing tactile image.

In some embodiments, the array of sensors can be transparent or translucent and can be provided with an underlying visual display element such as an alphanumeric and/or graphics and/or image display. The underlying visual display can comprise, for example, an LED array display, a backlit LCD, etc. Such an underlying display can be used to render geometric boundaries or labels for soft-key functionality implemented with the tactile sensor array, to display status information, etc. Tactile array sensors implemented as transparent touchscreens are taught in the 1999 filings of issued U.S. Pat. No. 6,570,078 and pending U.S. patent application Ser. No. 11/761,978.

In an embodiment, the touchpad or touchscreen can comprise a tactile sensor array obtains or provides individual measurements in every enabled cell in the sensor array that provides these as numerical values. The numerical values can be communicated in a numerical data array, as a sequential data stream, or in other ways. When regarded as a numerical data array with row and column ordering that can be associated with the geometric layout of the individual cells of the sensor array, the numerical data array can be regarded as representing a tactile image. The only tactile sensor array requirement to obtain the full functionality of the HDTP is that the tactile sensor array produce a multi-level gradient measurement image as a finger, part of hand, or other pliable object varies is proximity in the immediate area of the sensor surface.

Such a tactile sensor array should not be confused with the “null/contact” touchpad which, in normal operation, acts as a pair of orthogonally responsive potentiometers. These “null/contact” touchpads do not produce pressure images, proximity images, or other image data but rather, in normal operation, two voltages linearly corresponding to the location of a left-right edge and forward-back edge of a single area of contact. Such “null/contact” touchpads, which are universally found in existing laptop computers, are discussed and differentiated from tactile sensor arrays in issued U.S. Pat. No. 6,570,078 and pending U.S. patent application Ser. No. 11/761,978 (pre-grant publication US 2007/0229477). Before leaving this topic, it is pointed out that these the “null/contact” touchpads nonetheless can be inexpensively adapted with simple analog electronics to provide at least primitive multi-touch capabilities as taught in issued U.S. Pat. No. 6,570,078 and pending U.S. patent application Ser. No. 11/761,978 (therein, paragraphs [0022]-[0029], for example).

More specifically, FIG. 4 illustrates the side view of a finger 401 lightly touching the surface 402 of a tactile sensor array. In this example, the finger 401 contacts the tactile sensor surface in a relatively small area 403. In this situation, on either side the finger curves away from the region of contact 403, where the non-contacting yet proximate portions of the finger grow increasingly far 404a, 405a, 404b, 405b from the surface of the sensor 402. These variations in physical proximity of portions of the finger with respect to the sensor surface should cause each sensor element in the tactile proximity sensor array to provide a corresponding proximity measurement varying responsively to the proximity, separation distance, etc. The tactile proximity sensor array advantageously comprises enough spatial resolution to provide a plurality of sensors within the area occupied by the finger (for example, the area comprising width 406). In this case, as the finger is pressed down, the region of contact 403 grows as the more and more of the pliable surface of the finger conforms to the tactile sensor array surface 402, and the distances 404a, 405a, 404b, 405b contract. If the finger is tilted, for example by rolling in the user viewpoint counterclockwise (which in the depicted end-of-finger viewpoint clockwise 407a) the separation distances on one side of the finger 404a, 405a will contract while the separation distances on one side of the finger 404b, 405b will lengthen. Similarly if the finger is tilted, for example by rolling in the user viewpoint clockwise (which in the depicted end-of-finger viewpoint counterclockwise 407b) the separation distances on the side of the finger 404b, 405b will contract while the separation distances on the side of the finger 404a, 405a will lengthen.

In many various embodiments, the tactile sensor array can be connected to interface hardware that sends numerical data responsive to tactile information captured by the tactile sensor array to a processor. In various embodiments, this processor will process the data captured by the tactile sensor array and transform it various ways, for example into a collection of simplified data, or into a sequence of tactile image “frames” (this sequence akin to a video stream), or into highly refined information responsive to the position and movement of one or more fingers and/or other parts of the hand.

As to further detail of the latter example, a “frame” refers to a 2-dimensional list, number of rows by number of columns, of tactile measurement value of every pixel in a tactile sensor array at a given instance. The time interval between one frame and the next one depends on the frame rate of the system and the number of frames in a unit time (usually frames per second). FIG. 5a is a graphical representation of a tactile image produced by contact with the bottom surface of the most outward section (between the end of the finger and the most nearby joint) of a human finger on a tactile sensor array. In this tactile array, there are 24 rows and 24 columns; other realizations can have significantly more (hundreds or thousands) of rows and columns. Tactile measurement values of each cell are indicated by the numbers and shading in each cell. Darker cells represent cells with higher tactile measurement values. Similarly, FIG. 5b provides a graphical representation of a tactile image produced by contact with multiple human fingers on a tactile sensor array. In other embodiments, there can be a larger or smaller number of pixels for a given images size, resulting in varying resolution. Additionally, there can be larger or smaller area with respect to the image size resulting in a greater or lesser potential measurement area for the region of contact to be located in or move about.

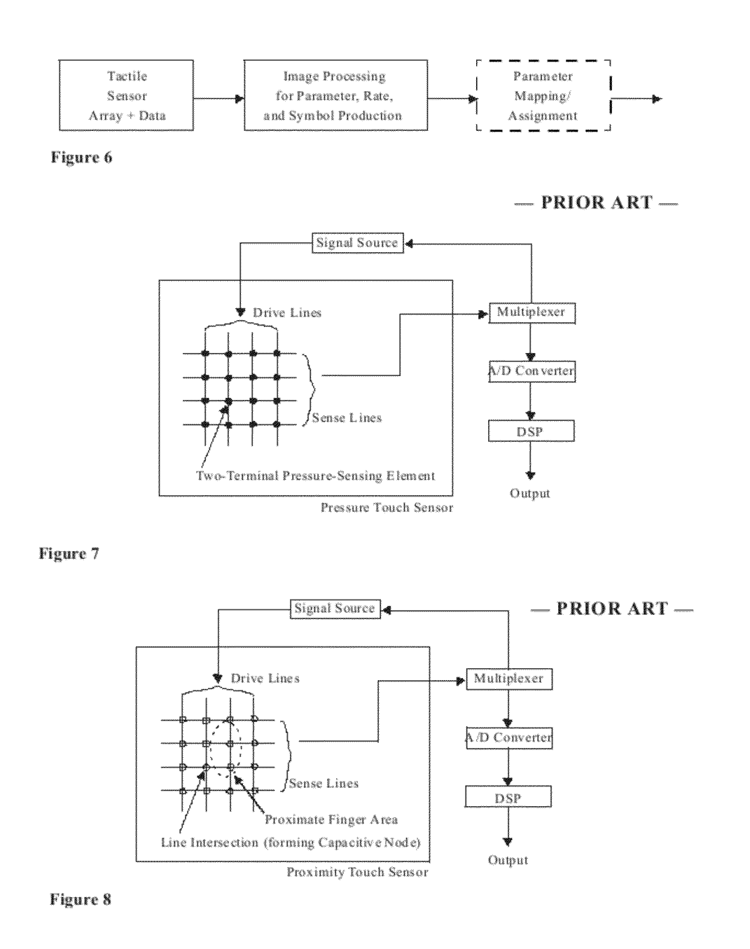

FIG. 6 depicts a realization wherein a tactile sensor array is provided with real-time or near-real-time data acquisition capabilities. The captured data reflects spatially distributed tactile measurements (such as pressure, proximity, etc.). The tactile sensory array and data acquisition stage provides this real-time or near-real-time tactile measurement data to a specialized image processing arrangement for the production of parameters, rates of change of those parameters, and symbols responsive to aspects of the hand's relationship with the tactile or other type of sensor array. In some applications, these measurements can be used directly. In other situations, the real-time or near-real-time derived parameters can be directed to mathematical mappings (such as scaling, offset, and/or nonlinear warpings) in real-time or near-real-time into real-time or near-real-time application-specific parameters or other representations useful for applications. In some embodiments, general purpose outputs can be assigned to variables defined or expected by the application.

Exemplary Types of Tactile Sensor Arrays

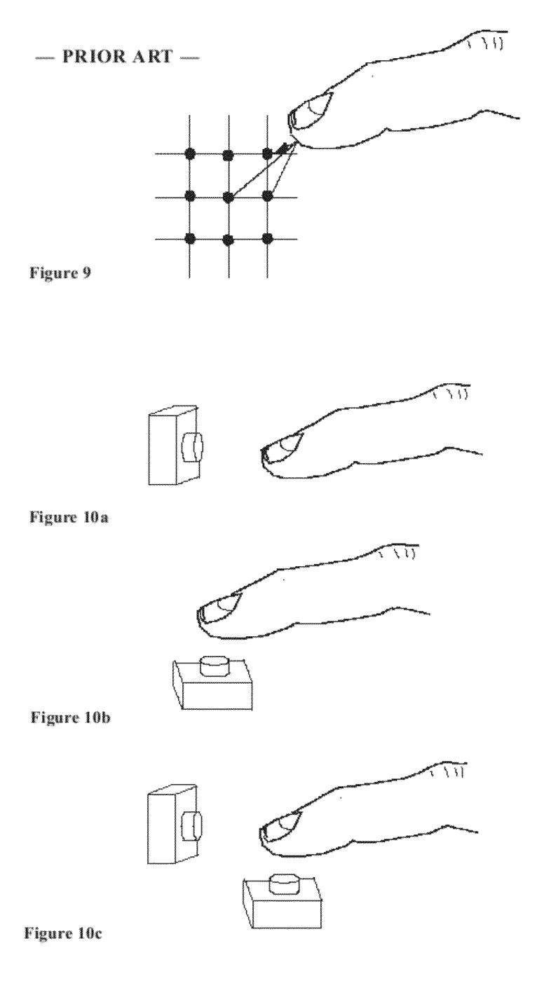

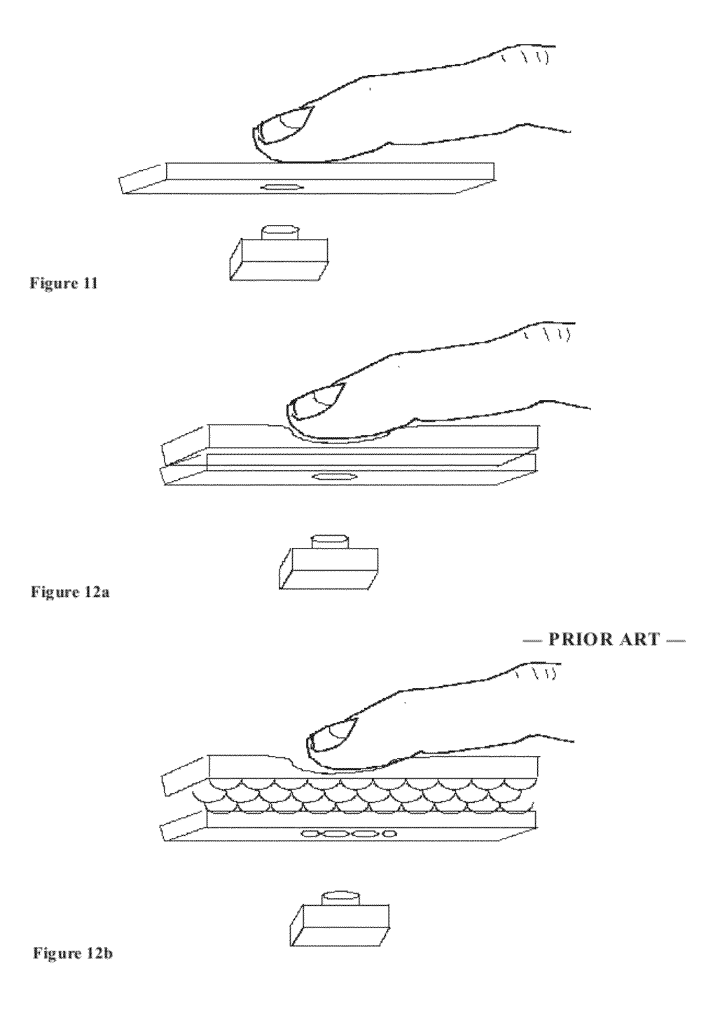

The tactile sensor array employed by HDTP technology can be implemented by a wide variety of means, for example:
Pressure sensor arrays (implemented by for example—although not limited to—one or more of resistive, capacitive, piezo, optical, acoustic, or other sensing elements);
Proximity sensor arrays (implemented by for example—although not limited to—one or more of capacitive, optical, acoustic, or other sensing elements);
Surface-contact sensor arrays (implemented by for example—although not limited to—one or more of resistive, capacitive, piezo, optical, acoustic, or other sensing elements).
   Below a few specific examples of the above are provided by way of illustration; however these are by no means limiting. The examples include:
Pressure sensor arrays comprising arrays of isolated sensors (FIG. 7);
Capacitive proximity sensors (FIG. 8);
Multiplexed LED optical reflective proximity sensors (FIG. 9);
Video camera optical reflective:
   direct image of hand (FIGS. 10a-10c);
   image of deformation of material (FIG. 11);
Surface contract refraction/absorption (FIG. 12)

An example implementation of a tactile sensor array is a pressure sensor array. Pressure sensor arrays discussed in U.S. Pat. No. 6,570,078 and pending U.S. patent application Ser. No. 11/761,978. FIG. 7 depicts a pressure sensor array arrangement comprising a rectangular array of isolated individual two-terminal pressure sensor elements. Such two-terminal pressure sensor elements typically operate by measuring changes in electrical (resistive, capacitive) or optical properties of an elastic material as the material is compressed. In typical embodiment, each sensor element in the sensor array can be individually accessed via multiplexing arrangement, for example as shown in FIG. 7, although other arrangements are possible and provided for by the invention. Examples of prominent manufacturers and suppliers of pressure sensor arrays include Tekscan, Inc. (307 West First Street., South Boston, Mass., 02127, www.tekscan.com), Pressure Profile Systems (5757 Century Boulevard, Suite 600, Los Angeles, Calif. 90045, www.pressureprofile.com), Sensor Products, Inc. (300 Madison Avenue, Madison, N.J. 07940 USA, www.sensorprod.com), and Xsensor Technology Corporation (Suite 111, 319-2nd Ave SW, Calgary, Alberta T2P 005, Canada, www.xsensor.com).

Capacitive proximity sensors can be used in various handheld devices with touch interfaces (see for example, among many, http://electronics.howstuffworks.com/iphone2.htm, http://www.veritasetvisus.com/VVTP-12,%20Walker.pdf). Prominent manufacturers and suppliers of such sensors, both in the form of opaque touchpads and transparent touch screens, include Balda AG (Bergkirchener Str. 228, 32549 Bad Oeynhausen, Del., www.balda.de), Cypress (198 Champion Ct., San Jose, Calif. 95134, www.cypress.com), and Synaptics (2381 Bering Dr., San Jose, Calif. 95131, www.synaptics.com). In such sensors, the region of finger contact is detected by variations in localized capacitance resulting from capacitive proximity effects induced by an overlapping or otherwise nearly-adjacent finger. More specifically, the electrical field at the intersection of orthogonally-aligned conductive buses is influenced by the vertical distance or gap between the surface of the sensor array and the skin surface of the finger. Such capacitive proximity sensor technology is low-cost, reliable, long-life, stable, and can readily be made transparent. FIG. 8 (adapted from http://www.veritasetvisus.com/VVTP-12,%20Walker.pdf with slightly more functional detail added) shows a popularly accepted view of a typical cell phone or PDA capacitive proximity sensor implementation. Capacitive sensor arrays of this type can be highly susceptible to noise and various shielding and noise-suppression electronics and systems techniques can need to be employed for adequate stability, reliability, and performance in various electric field and electromagnetically-noisy environments. In some embodiments of an HDTP, the present invention can use the same spatial resolution as current capacitive proximity touchscreen sensor arrays. In other embodiments of the present invention, a higher spatial resolution is advantageous.

Forrest M. Mims is credited as showing that an LED can be used as a light detector as well as a light emitter. Recently, light-emitting diodes have been used as a tactile proximity sensor array (for example, as depicted in the video available at http://cs.nyu.edu/˜jhan/ledtouch/index.html). Such tactile proximity array implementations typically need to be operated in a darkened environment (as seen in the video in the above web link). In one embodiment provided for by the invention, each LED in an array of LEDs can be used as a photodetector as well as a light emitter, although a single LED can either transmit or receive information at one time. Each LED in the array can sequentially be selected to be set to be in receiving mode while others adjacent to it are placed in light emitting mode. A particular LED in receiving mode can pick up reflected light from the finger, provided by said neighboring illuminating-mode LEDs. FIG. 9 depicts one implementation. The invention provides for additional systems and methods for not requiring darkness in the user environment in order to operate the LED array as a tactile proximity sensor. In one embodiment, potential interference from ambient light in the surrounding user environment can be limited by using an opaque pliable and/or elastically deformable surface covering the LED array that is appropriately reflective (directionally, amorphously, etc. as can be advantageous in a particular design) on the side facing the LED array. Such a system and method can be readily implemented in a wide variety of ways as is clear to one skilled in the art. In another embodiment, potential interference from ambient light in the surrounding user environment can be limited by employing amplitude, phase, or pulse width modulated circuitry and/or software to control the underlying light emission and receiving process. For example, in an implementation the LED array can be configured to emit modulated light modulated at a particular carrier frequency or variational waveform and respond to only modulated light signal components extracted from the received light signals comprising that same carrier frequency or variational waveform. Such a system and method can be readily implemented in a wide variety of ways as is clear to one skilled in the art.

Use of video cameras for gathering control information from the human hand in various ways is discussed in U.S. Pat. No. 6,570,078 and Pending U.S. patent application Ser. No. 10/683,915. Here the camera image array is employed as an HDTP tactile sensor array. Images of the human hand as captured by video cameras can be used as an enhanced multiple-parameter interface responsive to hand positions and gestures, for example as taught in U.S. patent application Ser. No. 10/683,915 Pre-Grant-Publication 2004/0118268 (paragraphs [314], [321]-[332], [411], [653], both stand-alone and in view of [325], as well as [241]-[263]). FIGS. 10a and 10b depict single camera implementations, while FIG. 10c depicts a two camera implementation. As taught in the aforementioned references, a wide range of relative camera sizes and positions with respect to the hand are provided for, considerably generalizing the arrangements shown in FIGS. 10a-10c

In another video camera tactile controller embodiment, a flat or curved transparent or translucent surface or panel can be used as sensor surface. When a finger is placed on the transparent or translucent surface or panel, light applied to the opposite side of the surface or panel reflects light in a distinctly different manner than in other regions where there is no finger or other tactile contact. The image captured by an associated video camera will provide gradient information responsive to the contact and proximity of the finger with respect to the surface of the translucent panel. For example, the parts of the finger that are in contact with the surface will provide the greatest degree of reflection while parts of the finger that curve away from the surface of the sensor provide less reflection of the light. Gradients of the reflected light captured by the video camera can be arranged to produce a gradient image that appears similar to the multilevel quantized image captured by a pressure sensor. By comparing changes in gradient, changes in the position of the finger and pressure applied by the finger can be detected. FIG. 11 depicts an implementation.

FIGS. 12a-12b depict an implementation of an arrangement comprising a video camera capturing the image of a deformable material whose image varies according to applied pressure. In the example of FIG. 12a, the deformable material serving as a touch interface surface can be such that its intrinsic optical properties change in response to deformations, for example by changing color, index of refraction, degree of reflectivity, etc. In another approach, the deformable material can be such that exogenous optic phenomena is modulated n response to the deformation. As an example, the arrangement of FIG. 12b is such that the opposite side of the deformable material serving as a touch interface surface comprises deformable bumps which flatten out against the rigid surface of a transparent or translucent surface or panel. The diameter of the image as seen from the opposite side of the transparent or translucent surface or panel increases as the localized pressure from the region of hand contact increases. Such an approach was created by Professor Richard M. White at U.C. Berkeley in the 1980's.

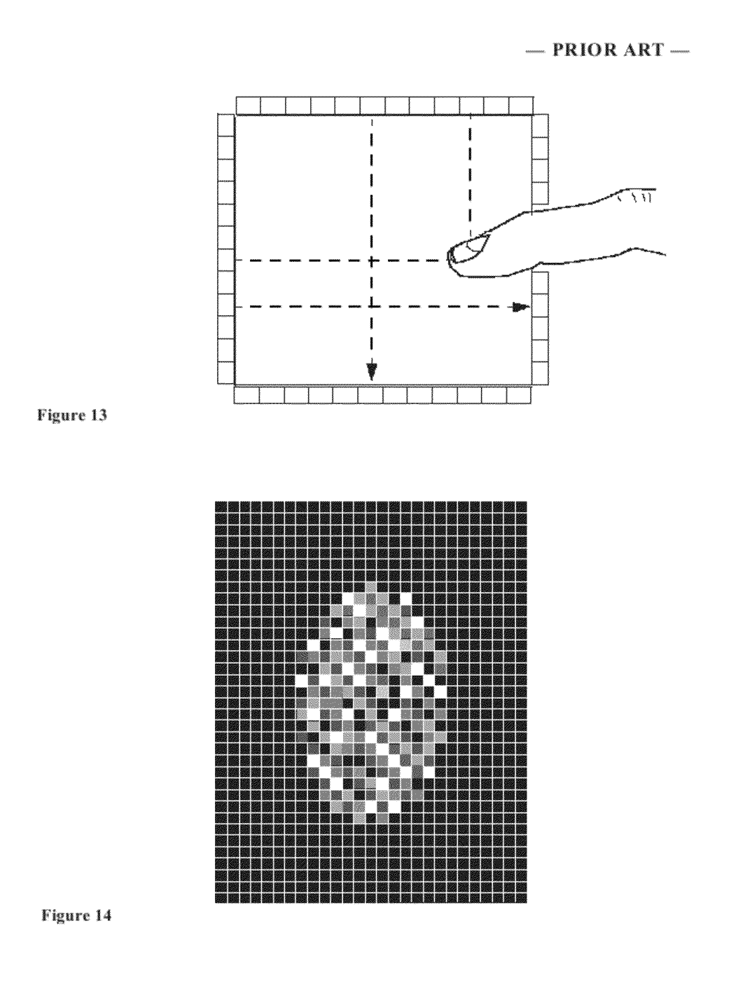

FIG. 13 depicts an optical or acoustic diffraction or absorption arrangement that can be used for contact or pressure sensing of tactile contact. Such a system can employ, for example light or acoustic waves. In this class of methods and systems, contact with or pressure applied onto the touch surface causes disturbances (diffraction, absorption, reflection, etc.) that can be sensed in various ways. The light or acoustic waves can travel within a medium comprised by or in mechanical communication with the touch surface. A slight variation of this is where surface acoustic waves travel along the surface of, or interface with, a medium comprised by or in mechanical communication with the touch surface.

Compensation for Non-Ideal Behavior of Tactile Sensor Arrays

Individual sensor elements in a tactile sensor array produce measurements that vary sensor-by-sensor when presented with the same stimulus. Inherent statistical averaging of the algorithmic mathematics can damp out much of this, but for small image sizes (for example, as rendered by a small finger and/or light contact), as well as in cases where there are extremely large variances in sensor element behavior from sensor to sensor, the invention provides for each sensor to be individually calibrated in implementations where that can be advantageous. Sensor-by-sensor measurement value scaling, offset, and/or nonlinear warpings can be invoked for all or selected sensor elements during data acquisition scans. Similarly, the invention provides for individual noisy or defective sensors can be tagged for omission during data acquisition scans.

FIG. 14 shows a finger image wherein rather than a smooth gradient in pressure or proximity values there is radical variation due to non-uniformities in offset and scaling terms among the sensors.

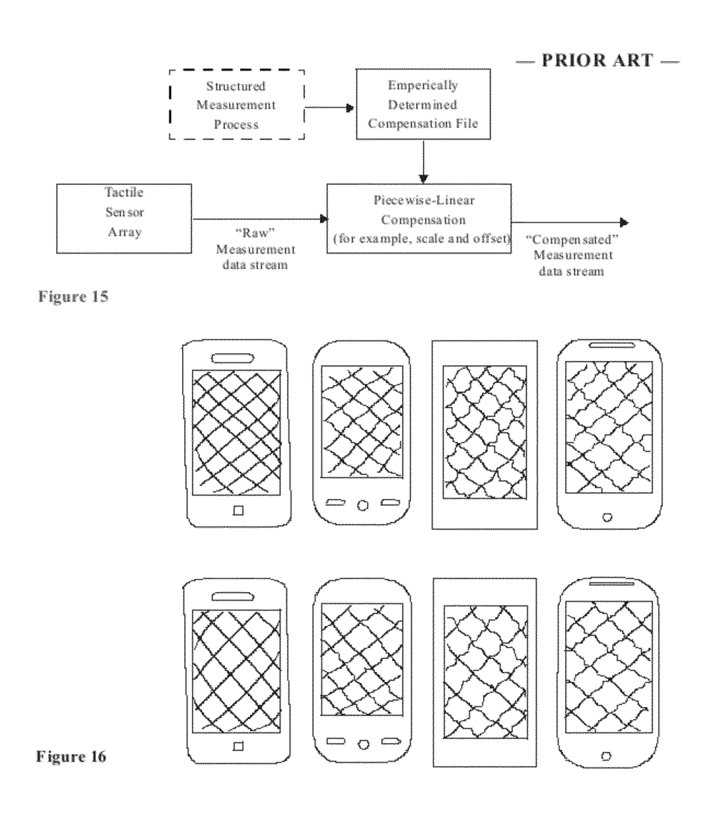

FIG. 15 show a sensor-by-sensor compensation arrangement for such a situation. A structured measurement process applies a series of known mechanical stimulus values (for example uniform applied pressure, uniform simulated proximity, etc.) to the tactile sensor array and measurements are made for each sensor. Each measurement data point for each sensor is compared to what the sensor should read and a piecewise-linear correction is computed. In an embodiment, the coefficients of a piecewise-linear correction operation for each sensor element is stored in a file. As the raw data stream is acquired from the tactile sensor array, sensor-by-sensor the corresponding piecewise-linear correction coefficients are obtained from the file and used to invoke a piecewise-linear correction operation for each sensor measurement. The value resulting from this time-multiplexed series of piecewise-linear correction operations forms an outgoing “compensated” measurement data stream. Such an arrangement is employed, for example, as part of the aforementioned Tekscan resistive pressure sensor array products.

Additionally, the macroscopic arrangement of sensor elements can introduce nonlinear spatial warping effects. As an example, various manufacturer implementations of capacitive proximity sensor arrays and associated interface electronics are known to comprise often dramatic nonlinear spatial warping effects. FIG. 16 (adapted from http://labs.moto.com/diy-touchscreen-analysis/) depicts the comparative performance of a group of contemporary handheld devices wherein straight lines were entered using the surface of the respective touchscreens. A common drawing program was used on each device, with widely-varying type and degrees of nonlinear spatial warping effects clearly resulting. For simple gestures such as selections, finger-flicks, drags, spreads, etc., such nonlinear spatial warping effects introduce little consequence. For more precision applications, such nonlinear spatial warping effects introduce unacceptable performance. Close study of FIG. 16 shows different types of responses to tactile stimulus in the direct neighborhood of the relatively widely-spaced capacitive sensing nodes versus tactile stimulus in the boundary regions between capacitive sensing nodes. Increasing the number of capacitive sensing nodes per unit area can reduce this, as can adjustments to the geometry of the capacitive sensing node conductors. In many cases improved performance can be obtained by introducing or more carefully implementing interpolation mathematics.

Exemplary Types of Hand Contact Measurements and Features Provided by HDTP Technology

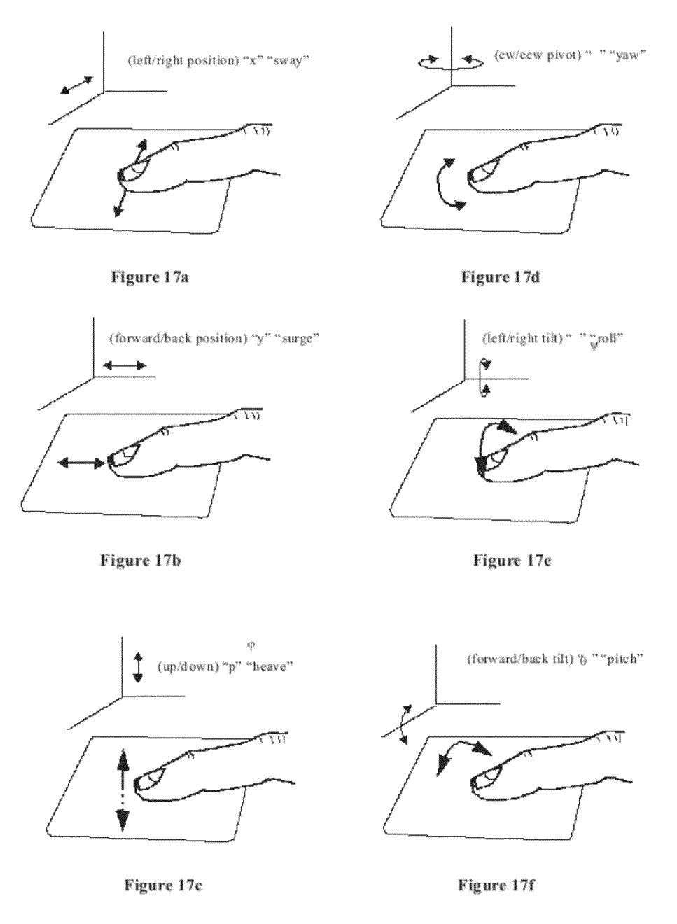

FIGS. 17a-17f illustrate the six independently adjustable degrees of freedom of touch from a single finger that can be simultaneously measured by the HDTP technology. The depiction in these figures is from the side of the touchpad. FIGS. 17a-17c show actions of positional change (amounting to applied pressure in the case of FIG. 17c) while FIGS. 17d-17f show actions of angular change. Each of these can be used to control a user interface parameter, allowing the touch of a single fingertip to control up to six simultaneously-adjustable quantities in an interactive user interface.

Each of the six parameters listed above can be obtained from operations on a collection of sums involving the geometric location and tactile measurement value of each tactile measurement sensor. Of the six parameters, the left-right geometric center (“x”), forward-back geometric center (“y”), and clockwise-counterclockwise yaw rotation (“ψ”) can be obtained from binary threshold image data. The average downward pressure (“p”), roll (“φ”), and pitch (“θ”) parameters are in some embodiments beneficially calculated from gradient (multi-level) image data. One remark is that because binary threshold image data is sufficient for the left-right geometric center, forward-back geometric center, and clockwise-counterclockwise yaw rotation parameters, these also can be discerned for flat regions of rigid non-pliable objects, and thus the HDTP technology thus can be adapted to discern these three parameters from flat regions with striations or indentations of rigid non-pliable objects.

These ‘Position Displacement’ parameters FIGS. 17a-17c can be realized by various types of unweighted averages computed across the blob of one or more of each the geometric location and tactile measurement value of each above-threshold measurement in the tactile sensor image. The pivoting rotation can be calculated from a least-squares slope which in turn involves sums taken across the blob of one or more of each the geometric location and the tactile measurement value of each active cell in the image; alternatively a high-performance adapted eigenvector method taught in co-pending provisional patent application U.S. 61/210,250 “High-Performance Closed-Form Single-Scan Calculation of Oblong-Shape Rotation Angles from Binary Images of Arbitrary Size Using Running Sums,” filed Mar. 14, 2009, can be used. The last two angle (“tilt”) parameters, pitch (“θ”) and roll (“φ”), can be realized by performing calculations on various types of weighted averages as well as a number of other methods.

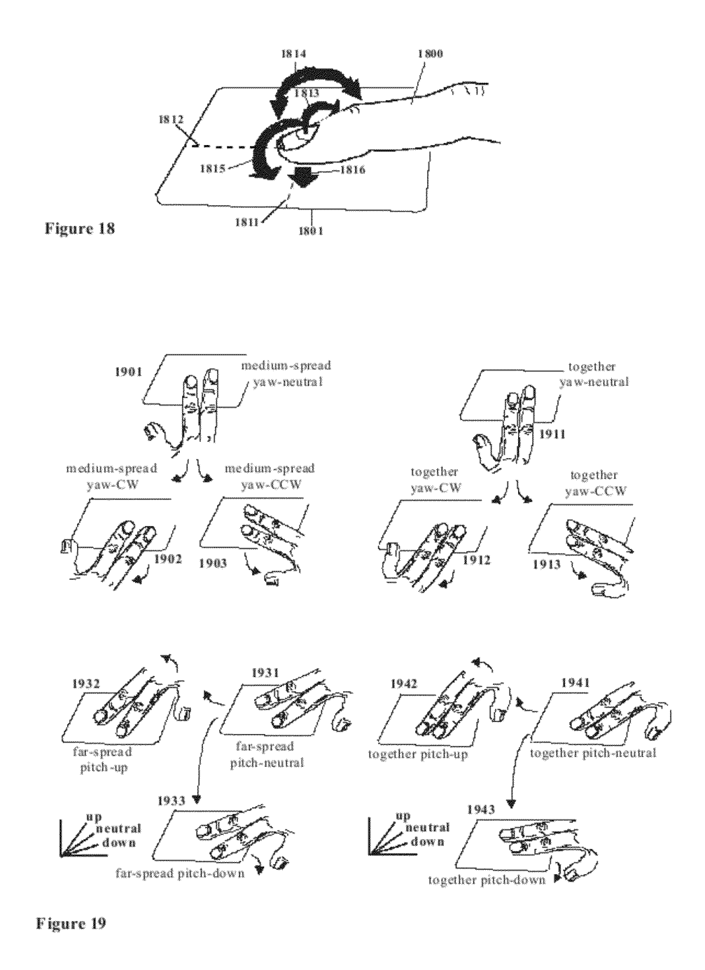

Each of the six parameters portrayed in FIGS. 17a-17f can be measured separately and simultaneously in parallel. FIG. 18 suggests general ways in which two or more of these independently adjustable degrees of freedom adjusted at once.

The HDTP technology provides for multiple points of contact, these days referred to as “multi-touch.” FIG. 19 demonstrates a few two-finger multi-touch postures and/or gestures from the hundreds that can be readily recognized by HTDP technology. HTDP technology can also be configured to recognize and measure postures and/or gestures involving three or more fingers, various parts of the hand, the entire hand, multiple hands, etc. Accordingly, the HDTP technology can be configured to measure areas of contact separately, recognize shapes, fuse measures or pre-measurement data so as to create aggregated measurements, and other operations.

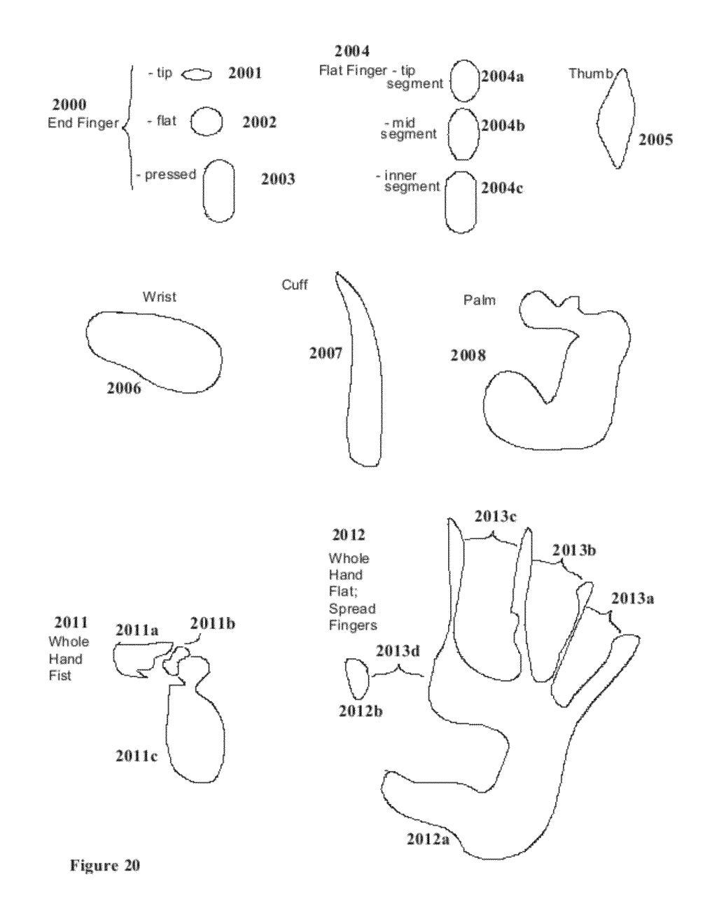

By way of example, FIG. 20 illustrates the pressure profiles for a number of example hand contacts with a pressure-sensor array. In the case 2000 of a finger's end, pressure on the touch pad pressure-sensor array can be limited to the finger tip, resulting in a spatial pressure distribution profile 2001; this shape does not change much as a function of pressure. Alternatively, the finger can contact the pad with its flat region, resulting in light pressure profiles 2002 which are smaller in size than heavier pressure profiles 2003. In the case 2004 where the entire finger touches the pad, a three-segment pattern (2004a, 2004b, 2004c) will result under many conditions; under light pressure a two segment pattern (2004b or 2004c missing) could result. In all but the lightest pressures the thumb makes a somewhat discernible shape 2005 as do the wrist 2006, edge-of-hand “cuff” 2007, and palm 2008; at light pressures these patterns thin and can also break into disconnected regions. Whole hand patterns such the first 2011 and flat hand 2012 have more complex shapes. In the case of the first 2011, a degree of curl can be discerned from the relative geometry and separation of sub-regions (here depicted, as an example, as 2011a, 2011b, and 2011c). In the case of the whole flat hand 2000, there can be two or more sub-regions which can be in fact joined (as within 2012a) and/or disconnected (as an example, as 2012a and 2012b are); the whole hand also affords individual measurement of separation “angles” among the digits and thumb (2013a, 2013b, 2013c, 2013d) which can easily be varied by the user.

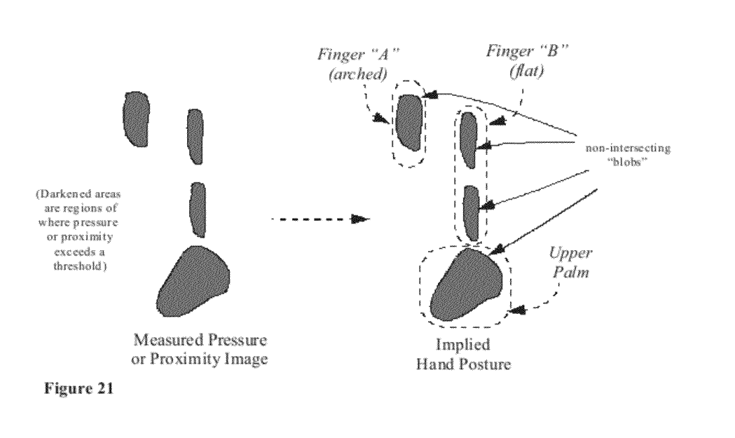

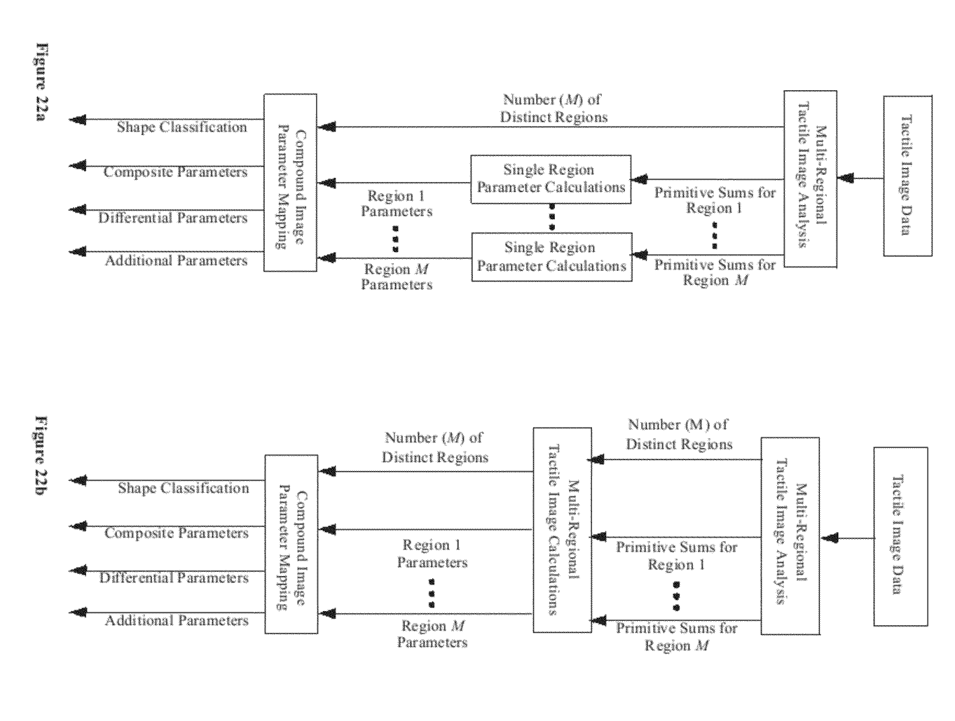

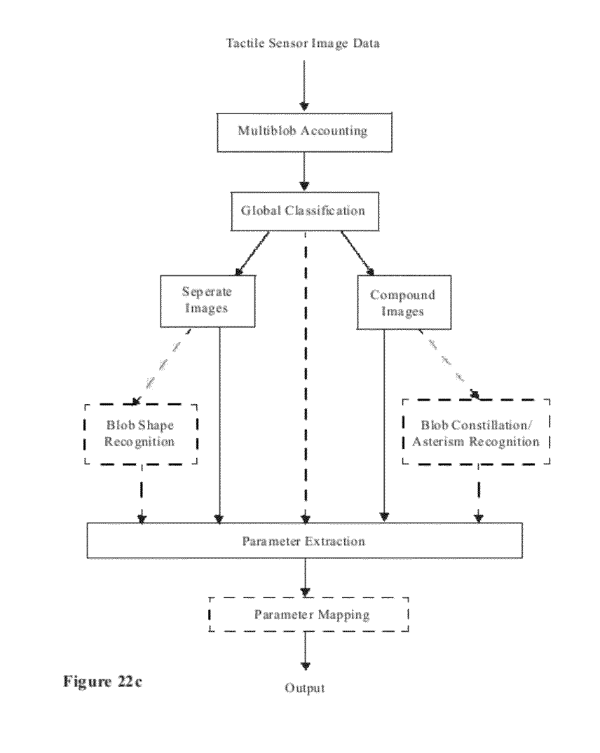

HDTP technology robustly provides feature-rich capability for tactile sensor array contact with two or more fingers, with other parts of the hand, or with other pliable (and for some parameters, non-pliable) objects. In one embodiment, one finger on each of two different hands can be used together to at least double number of parameters that can be provided. Additionally, new parameters particular to specific hand contact configurations and postures can also be obtained. By way of example, FIG. 21 depicts one of a wide range of tactile sensor images that can be measured by using more of the human hand. U.S. Pat. No. 6,570,078 and pending U.S. patent application Ser. No. 11/761,978 provide additional detail on use of other parts of hand. Within the context of the example of FIG. 21:
multiple fingers can be used with the tactile sensor array, with or without contact by other parts of the hand;
The whole hand can be tilted & rotated;
The thumb can be independently rotated in yaw angle with respect to the yaw angle held by other fingers of the hand;
Selected fingers can be independently spread, flatten, arched, or lifted;
The palms and wrist cuff can be used;
Shapes of individual parts of the hand and/or combinations of them can be recognized.
   Selected combinations of such capabilities can be used to provide an extremely rich pallet of primitive control signals that can be used for a wide variety of purposes and applications.

Other HDTP Processing, Signal Flows, and Operations

In order to accomplish this range of capabilities, HDTP technologies must be able to parse tactile images and perform operations based on the parsing. In general, contact between the tactile-sensor array and multiple parts of the same hand forfeits some degrees of freedom but introduces others. For example, if the end joints of two fingers are pressed against the sensor array as in FIG. 21, it will be difficult or impossible to induce variations in the image of one of the end joints in six different dimensions while keeping the image of the other end joints fixed. However, there are other parameters that can be varied, such as the angle between two fingers, the difference in coordinates of the finger tips, and the differences in pressure applied by each finger.

In general, compound images can be adapted to provide control over many more parameters than a single contiguous image can. For example, the two-finger postures considered above can readily pro-vide a nine-parameter set relating to the pair of fingers as a separate composite object adjustable within an ergonomically comfortable range. One example nine-parameter set the two-finger postures consider above is:
composite average x position;
inter-finger differential x position;
composite average y position;
inter-finger differential y position;
composite average pressure;
inter-finger differential pressure;
composite roll;
composite pitch;
composite yaw.

As another example, by using the whole hand pressed flat against the sensor array including the palm and wrist, it is readily possible to vary as many as sixteen or more parameters independently of one another. A single hand held in any of a variety of arched or partially-arched postures provides a very wide range of postures that can be recognized and parameters that can be calculated.

When interpreted as a compound image, extracted parameters such as geometric center, average downward pressure, tilt (pitch and roll), and pivot (yaw) can be calculated for the entirety of the asterism or constellation of smaller blobs. Additionally, other parameters associated with the asterism or constellation can be calculated as well, such as the aforementioned angle of separation between the fingers. Other examples include the difference in downward pressure applied by the two fingers, the difference between the left-right (“x”) centers of the two fingertips, and the difference between the two forward-back (“y”) centers of the two fingertips. Other compound image parameters are possible and are provided by HDTP technology.

There are number of ways for implementing the handling of compound posture data images. Two contrasting examples are depicted in FIGS. 22a-22b, although many other possibilities exist and are provided for by the invention. In the embodiment of FIG. 22a, tactile image data is examined for the number “M” of isolated blobs (“regions”) and the primitive running sums are calculated for each blob. This can be done, for example, with the algorithms described earlier. Post-scan calculations can then be performed for each blob, each of these producing an extracted parameter set (for example, x position, y position, average pressure, roll, pitch, yaw) uniquely associated with each of the M blobs (“regions”). The total number of blobs and the extracted parameter sets are directed to a compound image parameter mapping function to produce various types of outputs, including:
Shape classification (for example finger tip, first-joint flat finger, two-joint flat finger, three joint-flat finger, thumb, palm, wrist, compound two-finger, compound three-finger, composite 4-finger, whole hand, etc.);
Composite parameters (for example composite x position, composite y position, composite average pressure, composite roll, composite pitch, composite yaw, etc.);
Differential parameters (for example pair-wise inter-finger differential x position, pair-wise inter-finger differential y position, pair-wise inter-finger differential pressure; etc.);
Additional parameters (for example, rates of change with respect to time, detection that multiple finger images involve multiple hands, etc.).

FIG. 22b depicts an alternative embodiment, tactile image data is examined for the number M of isolated blobs (“regions”) and the primitive running sums are calculated for each blob, but this information is directed to a multi-regional tactile image parameter extraction stage. Such a stage can include, for example, compensation for minor or major ergonomic interactions among the various degrees of postures of the hand. The resulting compensation or otherwise produced extracted parameter sets (for example, x position, y position, average pressure, roll, pitch, yaw) uniquely associated with each of the M blobs and total number of blobs are directed to a compound image parameter mapping function to produce various types of outputs as described for the arrangement of FIG. 22a.

Additionally, embodiments of the invention can be set up to recognize one or more of the following possibilities:
Single contact regions (for example a finger tip);
Multiple independent contact regions (for example multiple fingertips of one or more hands);
Fixed-structure (“constellation”) compound regions (for example, the palm, multiple-joint finger contact as with a flat finger, etc.);
Variable-structure (“asterism”) compound regions (for example, the palm, multiple-joint finger contact as with a flat finger, etc.).

Embodiments that recognize two or more of these possibilities can further be able to discern and process combinations of two more of the possibilities.

FIG. 22c depicts a simple system for handling one, two, or more of the above listed possibilities, individually or in combination. In the general arrangement depicted, tactile sensor image data is analyzed (for example, in the ways described earlier) to identify and isolate image data associated with distinct blobs. The results of this multiple-blob accounting is directed to one or more global classification functions set up to effectively parse the tactile sensor image data into individual separate blob images and/or individual compound images. Data pertaining to these individual separate blob and/or compound images are passed on to one or more parallel and/or serial parameter extraction functions. The one or more parallel and/or serial parameter extraction functions can also be provided information directly from the global classification function(s). Additionally, data pertaining to these individual separate blob and/or compound images are passed on to additional image recognition function(s), the output of which can also be provided to one or more parallel and/or serial parameter extraction function(s). The output(s) of the parameter extraction function(s) can then be either used directly, or first processed further by parameter mapping functions. Clearly other implementations are also possible to one skilled in the art and these are provided for by the invention.

Refining of the HDTP User Experience

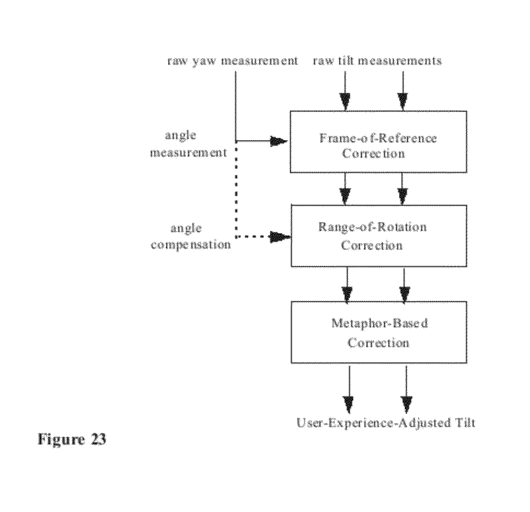

As an example of user-experience correction of calculated parameters, it is noted that placement of hand and wrist at a sufficiently large yaw angle can affect the range of motion of tilting. As the rotation angle increases in magnitude, the range of tilting motion decreases as mobile range of human wrists gets restricted. The invention provides for compensation for the expected tilt range variation as a function of measured yaw rotation angle. An embodiment is depicted in the middle portion of FIG. 23. As another example of user-experience correction of calculated parameters, the user and application can interpret the tilt measurement in a variety of ways. In one variation for this example, tilting the finger can be interpreted as changing an angle of an object, control dial, etc. in an application. In another variation for this example, tilting the finger can be interpreted by an application as changing the position of an object within a plane, shifting the position of one or more control sliders, etc. Typically each of these interpretations would require the application of at least linear, and typically nonlinear, mathematical transformations so as to obtain a matched user experience for the selected metaphor interpretation of tilt. In one embodiment, these mathematical transformations can be performed as illustrated in the lower portion of FIG. 23. The invention provides for embodiments with no, one, or a plurality of such metaphor interpretation of tilt.

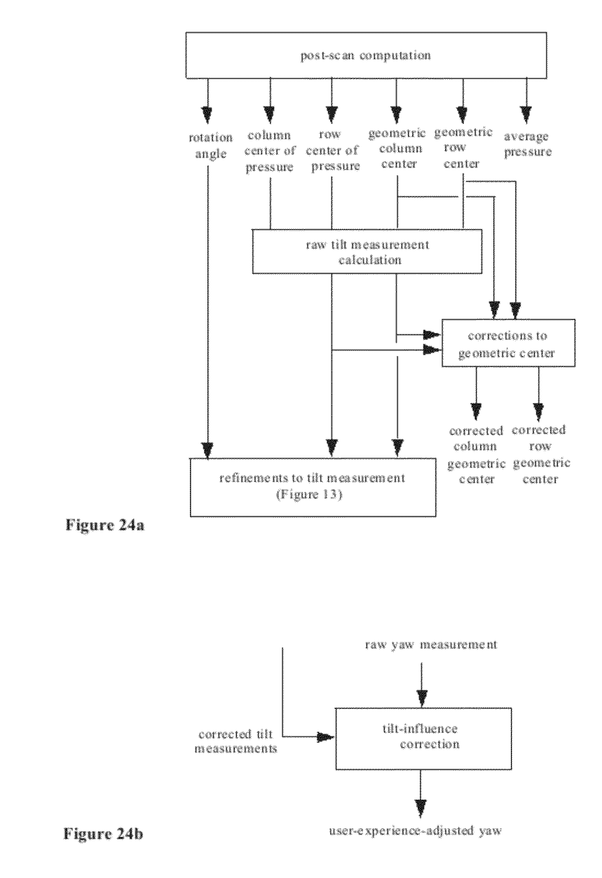

As the finger is tilted to the left or right, the shape of the area of contact becomes narrower and shifts away from the center to the left or right. Similarly as the finger is tilted forward or backward, the shape of the area of contact becomes shorter and shifts away from the center forward or backward. For a better user experience, the invention provides for embodiments to include systems and methods to compensate for these effects (i.e. for shifts in blob size, shape, and center) as part of the tilt measurement portions of the implementation. Additionally, the raw tilt measures can also typically be improved by additional processing. FIG. 24a depicts an embodiment wherein the raw tilt measurement is used to make corrections to the geometric center measurement under at least conditions of varying the tilt of the finger. Additionally, the invention provides for yaw angle compensation for systems and situations wherein the yaw measurement is sufficiently affected by tilting of the finger. An embodiment of this correction in the data flow is shown in FIG. 24b.

Additional HDTP Processing, Signal Flows, and Operations

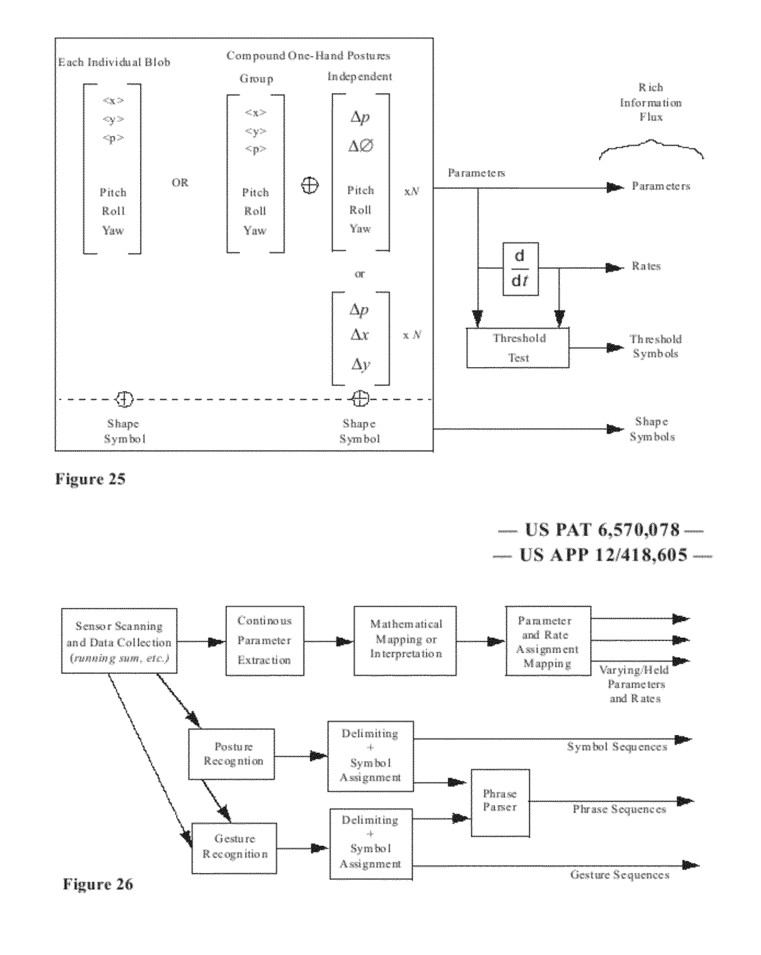

FIG. 25 shows an example of how raw measurements of the six quantities of FIGS. 17a-17f, together with shape recognition for distinguishing contact with various parts of the hand and the touchpad, can be used to create a rich information flux of parameters, rates, and symbols.

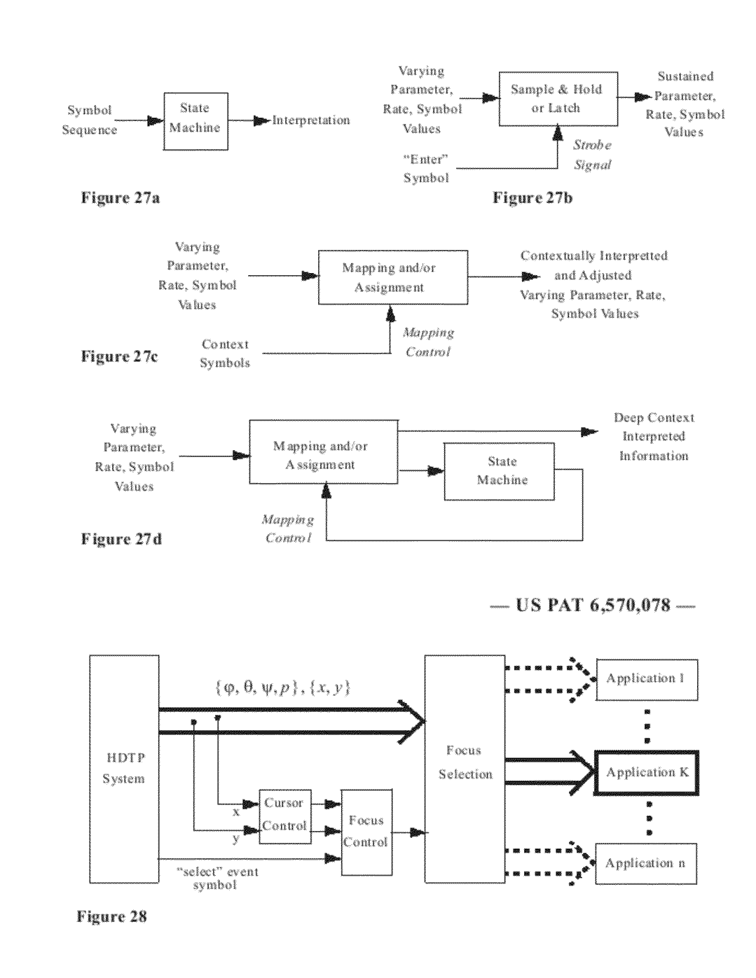

The HDTP affords and provides for yet further capabilities. For example, sequence of symbols can be directed to a state machine, as shown in FIG. 27a, to produce other symbols that serve as interpretations of one or more possible symbol sequences. In an embodiment, one or more symbols can be designated the meaning of an “Enter” key, permitting for sampling one or more varying parameter, rate, and/or symbol values and holding the value(s) until, for example, another “Enter” event, thus producing sustained values as illustrated in FIG. 27b. In an embodiment, one or more symbols can be designated as setting a context for interpretation or operation and thus control mapping and/or assignment operations on parameter, rate, and/or symbol values as shown in FIG. 27c. The operations associated with FIGS. 27a-27c can be combined to provide yet other capabilities. For example, the arrangement of FIG. 26d shows mapping and/or assignment operations that feed an interpretation state machine which in turn controls mapping and/or assignment operations. In implementations where context is involved, such as in arrangements such as those depicted in FIGS. 27b-27d, the invention provides for both context-oriented and context-free production of parameter, rate, and symbol values. The parallel production of context-oriented and context-free values can be useful to drive multiple applications simultaneously, for data recording, diagnostics, user feedback, and a wide range of other uses.

FIG. 28 depicts a user arrangement incorporating one or more HDTP system(s) or subsystem(s) that provide(s) user interface input event and routing of HDTP produced parameter values, rate values, symbols, etc. to a variety of applications. In an embodiment, these parameter values, rate values, symbols, etc. can be produced for example by utilizing one or more of the individual systems, individual methods, and/or individual signals described above in conjunction with the discussion of FIGS. 25, 26, and 27a-27b. As discussed later, such an approach can be used with other rich multiparameter user interface devices in place of the HDTP. The arrangement of FIG. 27 was also taught in pending U.S. patent application Ser. No. 12/502,230 “Control of Computer Window Systems, Computer Applications, and Web Applications via High Dimensional Touchpad User Interface” by Seung Lim, and FIG. 28 is adapted from FIG. 6e of that pending application (U.S. patent application Ser. No. 12/502,230) for further expansion here.

In an arrangement such as the one of FIG. 28, or in other implementations, at least two parameters are used for navigation of the cursor when the overall interactive user interface system is in a mode recognizing input from cursor control. These can be, for example, the left-right (“x”) parameter and forward/back (“y”) parameter provided by the touchpad. The arrangement of FIG. 28 includes an implementation of this.

Alternatively, these two cursor-control parameters can be provided by another user interface device, for example another touchpad or a separate or attached mouse.

In some situations, control of the cursor location can be implemented by more complex means. One example of this would be the control of location of a 3D cursor wherein a third parameter must be employed to specify the depth coordinate of the cursor location. For these situations, the arrangement of FIG. 28 would be modified to include a third parameter (for use in specifying this depth coordinate) in addition to the left-right (“x”) parameter and forward/back (“y”) parameter described earlier.

Focus control is used to interactively routing user interface signals among applications. In most current systems, there is at least some modality wherein the focus is determined by either the current cursor location or a previous cursor location when a selection event was made. In the user experience, this selection event typically involves the user interface providing an event symbol of some type (for example a mouse click, mouse double-click touchpad tap, touchpad double-tap, etc). The arrangement of FIG. 28 includes an implementation wherein a select event generated by the touchpad system is directed to the focus control element. The focus control element in this arrangement in turn controls a focus selection element that directs all or some of the broader information stream from the HDTP system to the currently selected application. (In FIG. 28, “Application K” has been selected as indicated by the thick-lined box and information-flow arrows.)

In some embodiments, each application that is a candidate for focus selection provides a window displayed at least in part on the screen, or provides a window that can be deiconified from an icon tray or retrieved from beneath other windows that can be obfuscating it. In some embodiments, if the background window is selected, focus selection element that directs all or some of the broader information stream from the HDTP system to the operating system, window system, and/or features of the background window. In some embodiments, the background window can be in fact regarded as merely one of the applications shown in the right portion of the arrangement of FIG. 28. In other embodiments, the background window can be in fact regarded as being separate from the applications shown in the right portion of the arrangement of FIG. 28. In this case the routing of the broader information stream from the HDTP system to the operating system, window system, and/or features of the background window is not explicitly shown in FIG. 28.

Use of the Additional HDTP Parameters by Applications

The types of human-machine geometric interaction between the hand and the HDTP facilitate many useful applications within a visualization environment. A few of these include control of visualization observation viewpoint location, orientation of the visualization, and controlling fixed or selectable ensembles of one or more of viewing parameters, visualization rendering parameters, pre-visualization operations parameters, data selection parameters, simulation control parameters, etc. As one example, the 6D orientation of a finger can be naturally associated with visualization observation viewpoint location and orientation, location and orientation of the visualization graphics, etc. As another example, the 6D orientation of a finger can be naturally associated with a vector field orientation for introducing synthetic measurements in a numerical simulation.

As yet another example, at least some aspects of the 6D orientation of a finger can be naturally associated with the orientation of a robotically positioned sensor providing actual measurement data. As another example, the 6D orientation of a finger can be naturally associated with an object location and orientation in a numerical simulation. As another example, the large number of interactive parameters can be abstractly associated with viewing parameters, visualization rendering parameters, pre-visualization operations parameters, data selection parameters, numeric simulation control parameters, etc.

In yet another example, the x and y parameters provided by the HDTP can be used for focus selection and the remaining parameters can be used to control parameters within a selected GUI.

In still another example, the x and y parameters provided by the HDTP can be regarded as a specifying a position within an underlying base plane and the roll and pitch angles can be regarded as a specifying a position within a superimposed parallel plane. In a first extension of the previous two-plane example, the yaw angle can be regarded as the rotational angle between the base and superimposed planes. In a second extension of the previous two-plane example, the finger pressure can be employed to determine the distance between the base and superimposed planes. In a variation of the previous two-plane example, the base and superimposed plane can not be fixed as parallel but rather intersect as an angle associated with the yaw angle of the finger. In the each of these, either or both of the two planes can represent an index or indexed data, a position, pair of parameters, etc. of a viewing aspect, visualization rendering aspect, pre-visualization operations, data selection, numeric simulation control, etc.

A large number of additional approaches are possible as is appreciated by one skilled in the art. These are provided for by the invention.

Support for Additional Parameters Via Browser Plug-Ins

The additional interactively-controlled parameters provided by the HDTP provide more than the usual number supported by conventional browser systems and browser networking environments. This can be addressed in a number of ways.

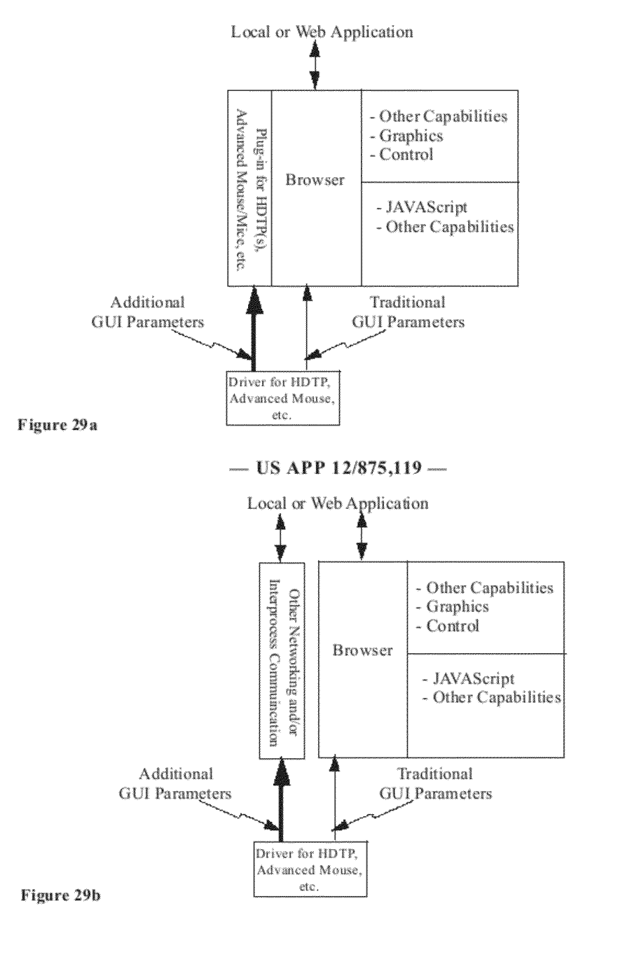

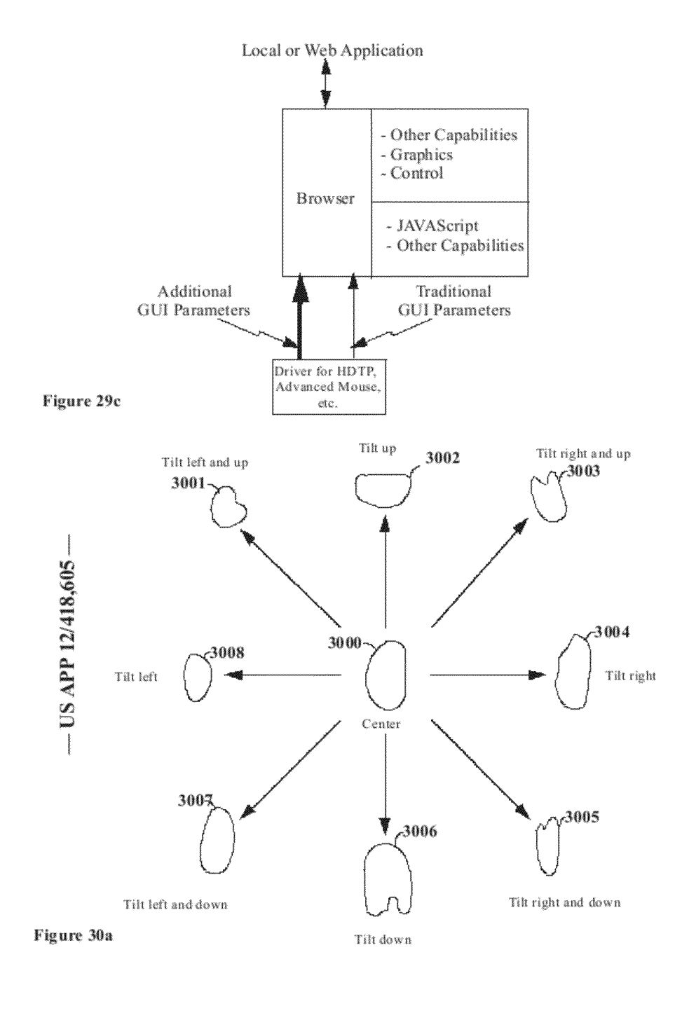

In a first approach, an HDTP interfaces with a browser both in a traditional way and additionally via a browser plug-in. Such an arrangement can be used to capture the additional user interface input parameters and pass these on to an application interfacing to the browser. An example of such an arrangement is depicted in FIG. 29a.

In a second approach, an HDTP interfaces with a browser in a traditional way and directs additional GUI parameters though other network channels. Such an arrangement can be used to capture the additional user interface input parameters and pass these on to an application interfacing to the browser. An example of such an arrangement is depicted in FIG. 29b.

In a third approach, an HDTP interfaces all parameters to the browser directly. Such an arrangement can be used to capture the additional user interface input parameters and pass these on to an application interfacing to the browser. An example of such an arrangement is depicted in FIG. 29c.

The browser can interface with local or web-based applications that drive the visualization and/or control the data source(s), process the data, etc. The browser can be provided with client-side software such as JAVA Script. The browser can provide also be configured advanced graphics to be rendered within the browser display environment, allowing the browser to be used as a viewer for data visualizations, advanced animations, etc., leveraging the additional multiple parameter capabilities of the HDTP. The browser can interface with local or web-based applications that drive the advanced graphics. In an embodiment, the browser can be provided with Simple Vector Graphics (“SVG”) utilities (natively or via an SVG plug-in) so as to render basic 2D vector and raster graphics. In another embodiment, the browser can be provided with a 3D graphics capability, for example via the Cortona 3D browser plug-in.

Multiple Parameter Extensions to Traditional Hypermedia Objects

The HDTP can be used to provide extensions to the traditional and contemporary hyperlink, roll-over, button, menu, and slider functions found in web browsers and hypermedia documents leveraging additional user interface parameter signals provided by an APD (i.e., HTPD, Advanced Mice, and other rich parameter user interfaces including currently popular advanced touch interfaces employing multitouch and/or gestures). The extensions provided by the invention include:
In the case of a hyperlink, button, slider and some menu features, directing additional user input into a hypermedia “hotspot” by clicking on it;
In the case of a roll-over and other menu features: directing additional user input into a hypermedia “hotspot” simply from cursor overlay or proximity (i.e., without clicking on it);
   The resulting extensions will be called “Multiparameter Hypermedia Objects” (“MHO”).

Potential uses of the MHOs and more generally extensions provided for by the invention include:
Using the additional user input to facilitate a rapid and/or more detailed information gathering experience in a low-barrier sub-session;
Potentially capturing notes from the sub-session for future use;
Potentially allowing the sub-session to retain state (such as last image displayed);
Leaving the hypermedia “hotspot” without clicking out of it.
   A number of user interface metaphors can be employed in the invention and/or its use, including one or more of:
Creating a pop-up visual or other visual change responsive to the rollover or hyperlink activation;
Rotating an object using rotation angle metaphors provided by the APD;
Rotating a user-experience observational viewpoint using rotation angle metaphors provided by the APD, for example, as described in pending U.S. patent application Ser. No. 12/502,230 “Control of Computer Window Systems, Computer Applications, and Web Applications via High Dimensional Touchpad User Interface” by Seung Lim;
Navigating at least one (1-dimensional) menu, (2-dimensional) pallet or hierarchical menu, or (3-dimensional) space.
   These extensions, features, and other aspects of the present invention permit far faster browsing, shopping, information gleaning through the enhanced features of these extended functionality roll-over and hyperlink objects.

In addition to MHOs that are additional-parameter extensions of traditional hypermedia objects, new types of MHOs unlike traditional or contemporary hypermedia objects can be implemented leveraging the additional user interface parameter signals and user interface metaphors that can be associated with them. Illustrative examples include:
Visual joystick (can keep position after release, or return to central position after release);
Visual rocker-button (can keep position after release, or return to central position after release);
Visual rotating trackball, cube, or other object (can keep position after release, or return to central position after release);
A small miniature touchpad).
   Yet other types of MHOs are possible and provided for by the invention. For example:
The background of the body page can be configured as an MHO;
The background of a frame or isolated section within a body page can be configured as an MHO;
An arbitrarily-shaped region, such as the boundary of an entity on a map, within a photograph, or within a graphic can be configured as an MHO.

In any of these, the invention provides for the MHO to be activated or selected by various means, for example by clicking or tapping when the cursor is displayed within the area, simply having the cursor displayed in the area (i.e., without clicking or tapping, as in rollover), etc.

It is anticipated that variations on any of these and as well as other new types of MHOs can similarly be crafted by those skilled in the art and these are provided for by the invention.

User Training

Since there is a great deal of variation from person to person, it is useful to include a way to train the invention to the particulars of an individual's hand and hand motions. For example, in a computer-based application, a measurement training procedure will prompt a user to move their finger around within a number of different positions while it records the shapes, patterns, or data derived from it for later use specifically for that user.

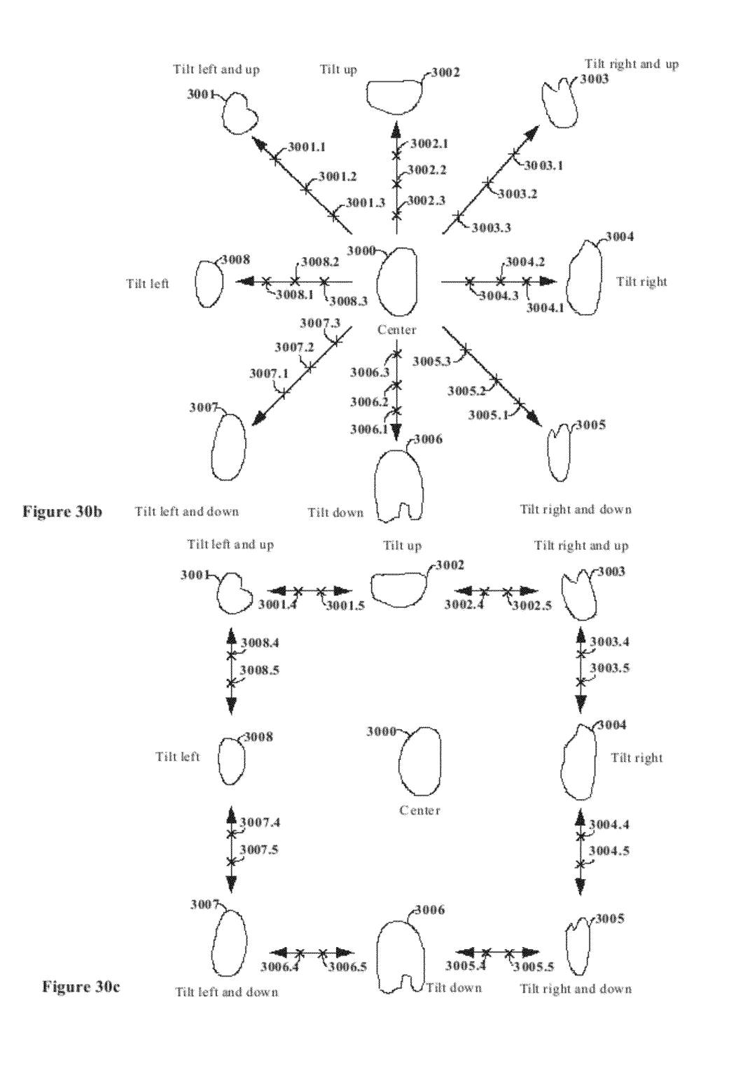

Typically most finger postures make a distinctive pattern. In one embodiment, a user-measurement training procedure could involve having the user prompted to touch the tactile sensor array in a number of different positions, for example as depicted in FIG. 30a. In some embodiments only extremal positions are recorded, such as the nine postures 3000-3008. In yet other embodiments, or cases wherein a particular user does not provide sufficient variation in image shape, additional postures can be included in the measurement training procedure, for example as depicted in FIG. 30b. In some embodiments, trajectories of hand motion as hand contact postures are changed can be recorded as part of the measurement training procedure, for example the eight radial trajectories as depicted in FIGS. 30a-30b, the boundary-tracing trajectories of FIG. 30c, as well as others that would be clear to one skilled in the art. All these are provided for by the invention.

The range in motion of the finger that can be measured by the sensor can subsequently be re-corded in at least two ways. It can either be done with a timer, where the computer will prompt user to move his finger from position 3000 to position 3001, and the tactile image imprinted by the finger will be recorded at points 3001.3, 3001.2 and 3001.1. Another way would be for the computer to query user to tilt their finger a portion of the way, for example “Tilt your finger ⅔ of the full range” and record that imprint. Other methods are clear to one skilled in the art and are provided for by the invention.

Additionally, this training procedure allows other types of shapes and hand postures to be trained into the system as well. This capability expands the range of contact possibilities and applications considerably. For example, people with physical handicaps can more readily adapt the system to their particular abilities and needs.

Multitouch Architecture

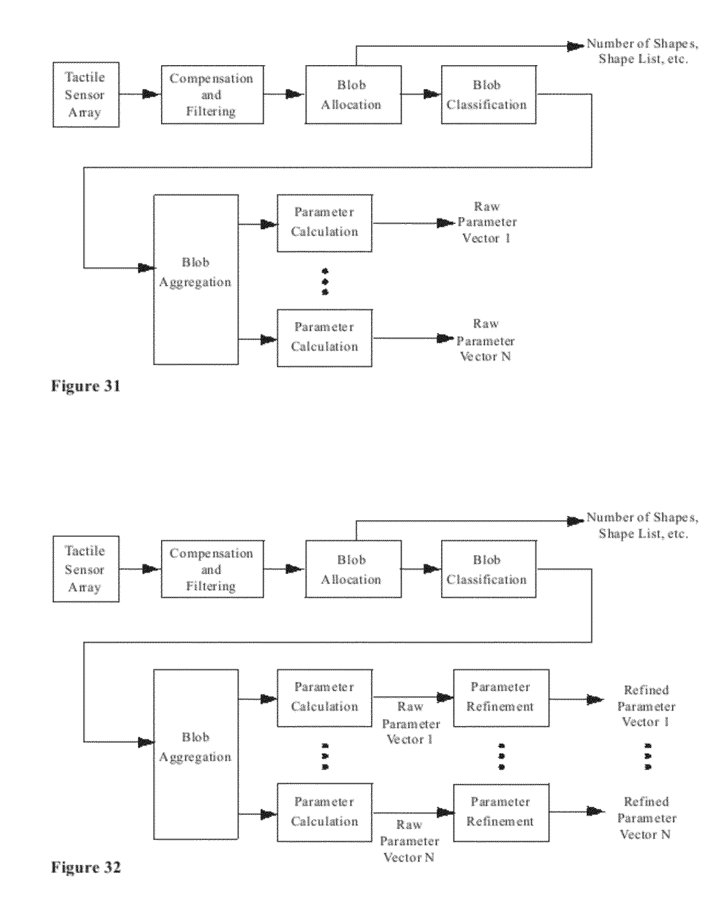

FIG. 31 depicts an HDTP signal flow chain for an HDTP realization implementing multi-touch, shape and constellation (compound shape) recognition, and other features. The results can be further processed to obtain symbols, provide additional mappings, etc. In this arrangement, depending on the number of points of contact and how they are interpreted and grouped, one or more shapes and/or constellations can be identified, counted, and listed, and one or more associated “raw” parameter vectors can be produced. The raw parameter vectors can comprise, for example, one or more of forward-back, left-right, downward pressure, roll, pitch, and yaw associated with a point of contact. In the case of a constellation, for example, other types of data can be in the parameter vector, for example inter-fingertip separation differences, differential pressures, etc.

Additional Parameter Refinement

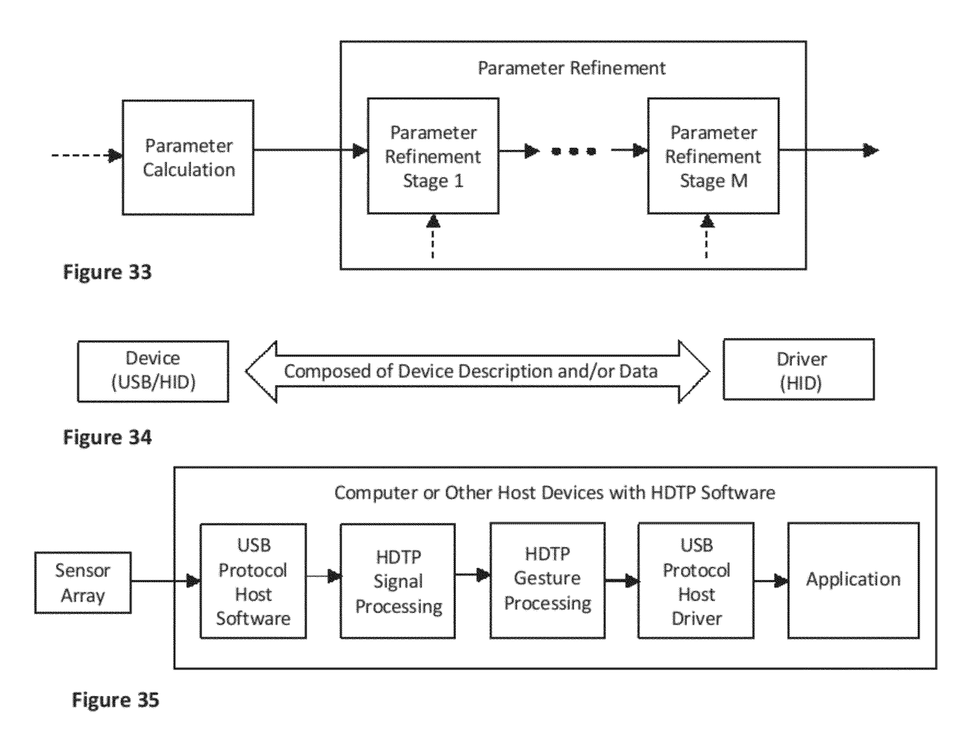

Additional refinement of the parameters can then be obtained by additional processing. As an example, FIG. 32 shows an adaptation of the arrangement of FIG. 31 wherein each raw parameter vector is provided to additional parameter refinement processing to produce a corresponding refined parameter vector. The additional parameter refinement can comprise a single stage as suggested in FIG. 32, or can internally comprise two or more internal parameter refinement stages as suggested in FIG. 33. The internal parameter refinement stages can be interconnected in various ways, including a simple chain, feedback and/or control paths (as suggested by the dash-line arrows within the Parameter Refinement box), as well as parallel paths (not explicitly suggested in FIG. 33), combinations, or other topologies as can be advantageous. The individual parameter refinement stages can comprise various approaches systems and methods, for example Kalman and/or other types of statistical filters, matched filters, artificial neural networks (such as but not limited to those taught in pending U.S. provisional patent application 61/309,421), linear or piecewise-linear transformations (such as but not limited to those taught in pending U.S. provisional patent application 61/327,458), nonlinear transformations, pattern recognition operations, dynamical systems, etc.

USB HID and Other Interfacing to Host Computer or Other Devices

In certain embodiments use of a USB interface in an HDTP implementation is useful, desirable, or required. FIG. 34 (adapted from Universal Serial Bus (USB) Device Class Definition for Human Interface Devices (HID) Version 1.11, currently available at the time of the patent application filing at the URL http://www.usb.org/developers/devclass_docs/HID1_{—}11.pdf) depicts a basic architecture for USB HID device software executing on a peripheral device and its interfacing, via USB hardware, with USB HID host driver software hosted the hosting computer or other device.

It is noted that although this section is directed towards various example implementations involving the Universal Serial Bus (USB), this section address more generally presenting HDTP technology to the rest of the computer system in standardized manner. For example:
A “virtual HID device” can be simulated in software. In this case it does not matter how sensor is connected to a host computer or other device (via more general USB, serial port, wireless link, Ethernet, TCP/IP, etc.)
A communications protocol endpoint is implemented on a peripheral HDTP device connected to a host computer or other device. From the host computer or other device viewpoint, the peripheral HDTP device looks like any other HID device and ready to use without any HDTP-specific software.
   These architectural variations, as well as many others, although discussed below in the context of the USB HID class, can be readily adapted to other communications arrangements such as more general USB, serial port, wireless link, Ethernet, TCP/IP, etc.

In a first example embodiment, an HDTP sensor that is connected to a computer or other device via an USB interface. Here the HDTP signal processing and any HDTP gesture processing are implemented on the hosting computer or other device. The HDTP signal processing and any HDTP gesture processing implementation can be realized via one or more of CPU software, GPU software, embedded processor software or firmware, and/or a dedicated integrated circuit. FIG. 35 depicts an implementation of such an embodiment. An example physical appearance of this arrangement can be represented by that depicted in FIG. 1a, but can also include that in FIGS. 1b-1g, 2a-2e, and 3a-3b.

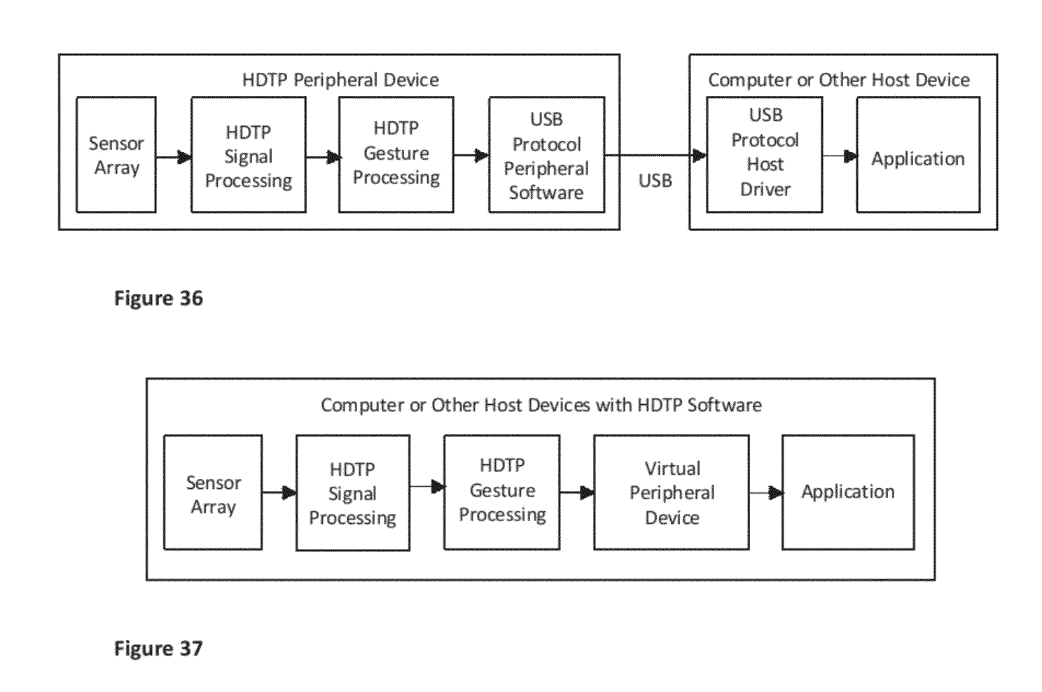

In second example embodiment, a USB HID device abstraction is employed to connect a host computer or other device with an HDTP sensor and one or more associated processor(s) which in turn is/are connected to the host computer via a USB interface. Here the HDTP signal processing and any HDTP gesture detection are implemented on the one or more processor(s) associated with HDTP sensor. The HDTP signal processing and any HDTP gesture processing implementation can be realized via one or more of CPU software, GPU software, embedded processor software or firmware, and/or a dedicated integrated circuit. FIG. 36 depicts an implementation of such an embodiment. An example physical appearance of this arrangement can be represented by that depicted in FIG. 1a, but can also include that in FIGS. 1b-1g, 2a-2e, and 3a-3b.

In a third example embodiment, a USB HID device abstraction is used as a software interface even though no USB port is actually used. Such an implementation is useful in cases where the HDTP is fully integrated into the host computer or other device, for example as in the case of a laptop computer, tablet computer, smartphone, etc. The HDTP signal processing and any HDTP gesture processing implementation can be realized via one or more of CPU software, GPU software, embedded processor software or firmware, and/or a dedicated integrated circuit. FIG. 37 depicts an implementation of such an embodiment. An example physical appearance of this arrangement can be represented by that depicted in FIGS. 1b-1g, 2a-2e, and 3a-3b.

In the case of the first example embodiment, the USB interface could, for example, be used to transport a tactile image or other pre-processed information. In the case of the second and third example embodiment, the invention provides for a USB HID device abstraction is used to provide HDTP user interface signals to one or more applications (as well as the operating system or windowing system in some implementations).

The USB HID device class provides an open interface useful for both traditional computer pointing devices such as the standard computer mouse as well as other user interface devices such as game controllers and the Logitech 3DConnexion SpaceNavigator™. The invention provides for the HDTP to interface one or more applications executing on a computer or other device through use of the USB HID device class.

As taught in the Universal Serial Bus (USB) Device Class Definition for Human Interface Devices (HID) Version 1.11, Section 3 (p. 4), information associated with a USB device comprises information “segments” called “Descriptors” which are used to identify a device as belonging to one of a collection of “classes.” The USB HID device class is used to identify and specify devices serving or performing as “Human Interface Devices” (HID). The USB HID device class is currently specified at the time of this patent application by at least the Universal Serial Bus (USB) Device Class Definition for Human Interface Devices (HID) Version 1.11 (Jun. 6, 2001). Some example HID implementations for various example peripheral devices are provided in Universal Serial Bus (USB) HID Usage Tables, Version 1.12 (Oct. 28, 2004), currently available at the time of the patent application filing at the URL http://www.usb.org/developers/devclass_docs/Hut1_{—}12v2.pdf.

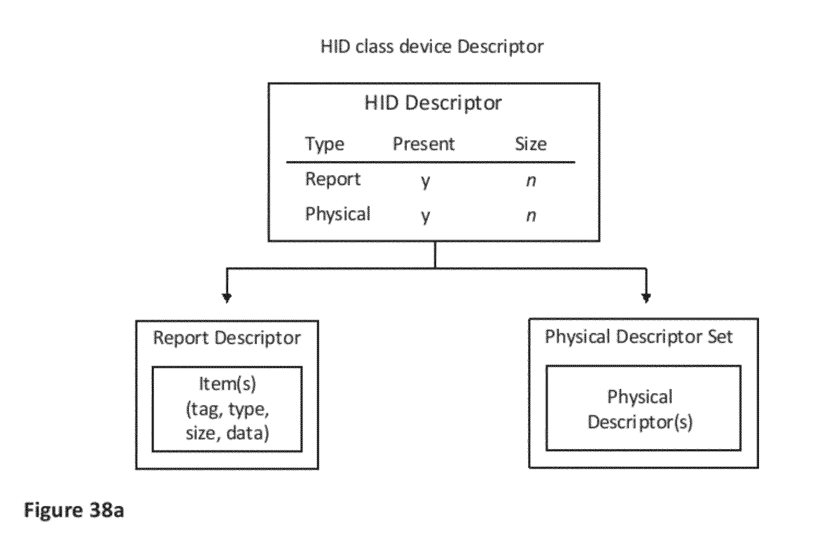

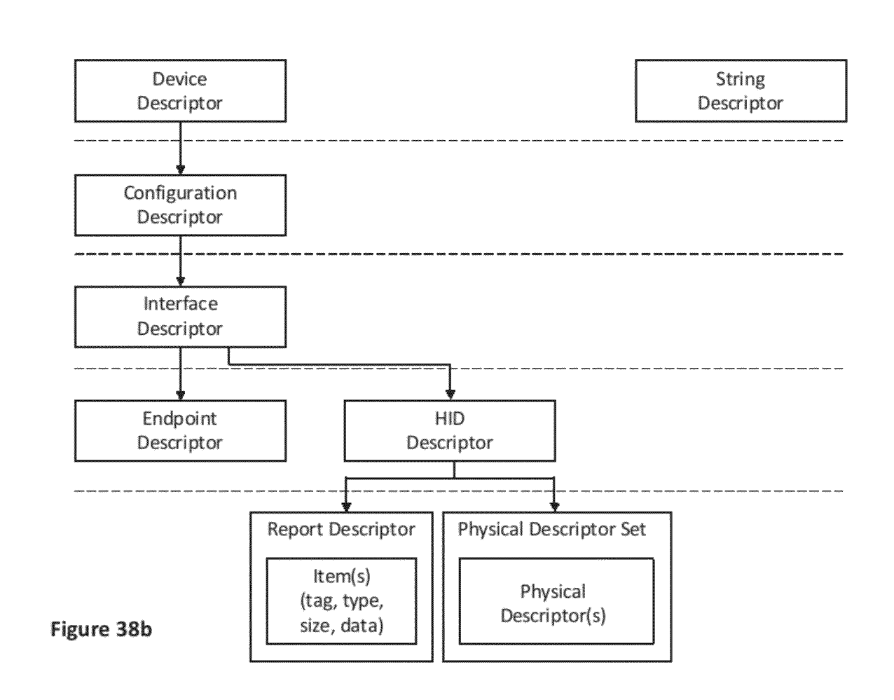

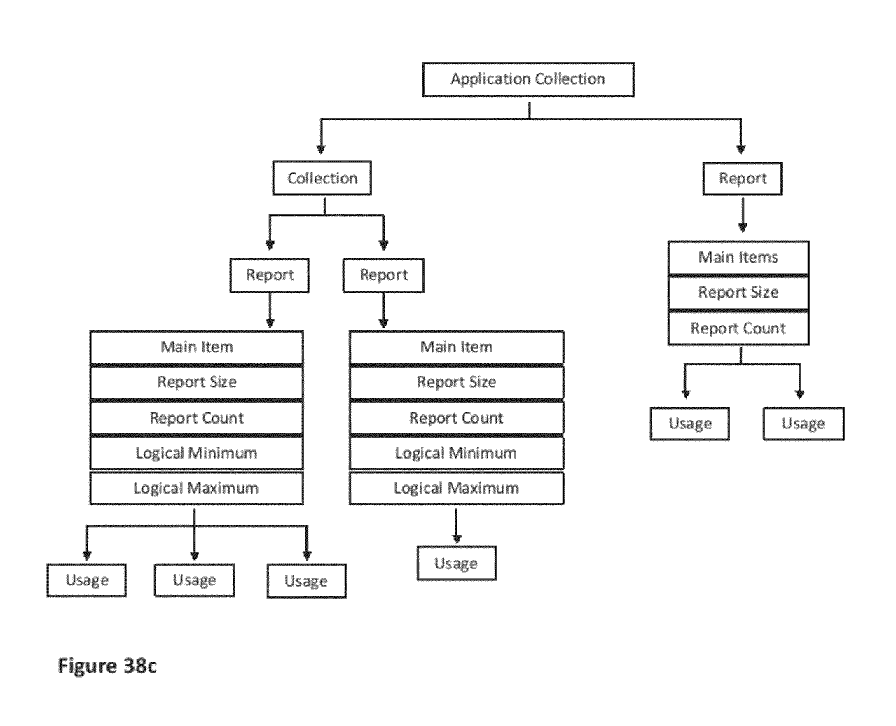

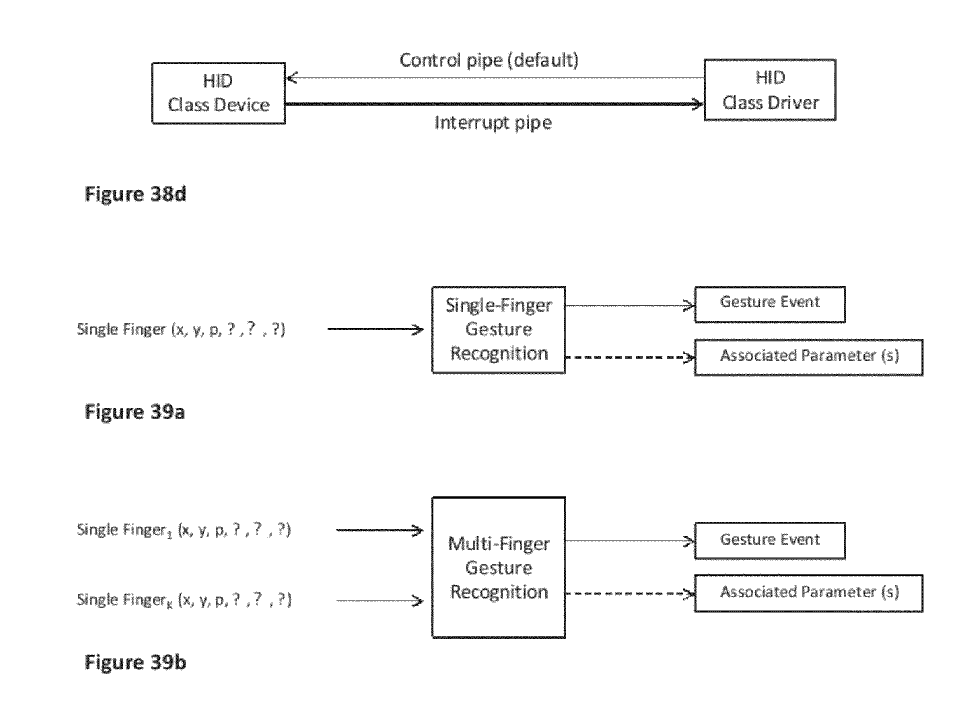

The HID device class comprises a descriptor called the “HID Descriptor” which in turn consists of a “Physical Descriptor Set” and a “Report Descriptor,” the Report Descriptor in turn comprising one or more “Item(s)” as shown in FIG. 38a (adapted from Universal Serial Bus (USB) Device Class Definition for Human Interface Devices (HID) Version 1.11). A useful view of the Report Descriptor is that of a data block in HID class protocol which describes the structure of subsequent data packets. The Physical Descriptor Set comprises optional descriptors providing information about how the physical controls are expected to be operated by a human user. The “Items(s)” in the Report Descriptor defines user controls and data measured or provided by them. Item information also provides routing and mapping information for the measured data. The invention provides for selected HDTP embodiments to use one or more Report Descriptor Item(s) to provide routing and mapping information for HDTP parameters and/or gestures.

In various embodiments, the HDTP communicating via USB HID could be configured to act as various types of devices communicate various events and parameters to a host computer or other device. The exact definition of each candidate device is implemented via Report Descriptors. There are established Report Descriptors such as for those for common devices like mouse, keyboard and game controllers, and custom devices can also readily be defined. Example fields within the Report Descriptors that are already supported are listed in the aforementioned Universal Serial Bus (USB) HID Usage Tables, Version 1.12. Some examples relevant to the HDTP include:
Use of an existing profile: An established, well-known descriptor can be used to allow the HDTP to mimic well known device. This allows existing software applications to readily and easily be operated by the HDTP touchpad. An example is the “Multi-axis controller;”
Use of a fixed custom profile: A custom HID descriptor can be defined with fields specific to the wider range of functionality provided by the HDTP. An example would include fields specifying “position” (i.e., “analog”) controls for HDTP forward-back, left-right, downward pressure, yaw, roll, and pitch and “one shot” controls for each gesture event symbol.
Use of custom and configurable profiles: A custom HID device descriptor could be generated based on general properties and/or specific settings of an HDTP embodiment. This can include providing users with a “properties” and/or specific customization user interface wherein the user selects what gesture events and parameters are to be used and how they map to HID controls. The invention also provides for the user to specify a plurality of custom HID device descriptors, allowing the user to have a HID device specifically tuned for particular applications.
   Custom profiles can be useful in carrying the outcomes of HDTP linguistic capabilities such as tactile grammars and metaphors, allowing detailed specification of mappings between these and HID controls. For example, a user can map linguistic concepts to selected HID controls. In general HDTP can be made user-configurable and include various types HID devices/profiles.

The arrangement associated with FIG. 38a in turn is part of a larger hierarchy depicted in FIG. 38b (adapted by combining several figures from Universal Serial Bus (USB) Device Class Definition for Human Interface Devices (HID) Version 1.11) wherein the “HID Descriptor” together with an “Endpoint descriptor” are comprised by an “Interface Descriptor” which in turn is a component of a “Configuration Descriptor” within the “Device Descriptor.” Peer to this (highest-level) Device Descriptor is a “String Descriptor.” The Device Descriptor includes information fields for information such as class, subclass (described below), vendor, product, and version. In more general USB implementations (i.e., broader than just the HID class), a USB device may have a plurality of configurations and each is accordingly defined in the Configuration Descriptor. Typically an HID class device offers only a single configuration. The invention provides for some HDTP embodiments to provide only a single configuration and thus only use one Configuration Descriptor. The invention also provides for other HDTP embodiments to use provide a plurality of configurations and thus provide a plurality of Configuration Descriptors.

The Interface Descriptor also has broader roles in the support of various USB devices and implementations, but in the case of HID devices the class field of the Interface Descriptor is used to define the peripheral device as a HID class device. The invention provides for selected HDTP embodiments to include an Interface Descriptor with class field used to define the HDTP as a HID class device.

The HID specification also include notions of subclasses and subclass protocols, but typically these are problematic and by default the Report Descriptor is typically used for creating protocols for existing and new human interface devices. The invention provides for selected HDTP embodiments to use one or more Report Descriptor Item(s) for creating HID protocols.

The subclass formalism is typically used for devices involved in machine booting operations (such as BIOS), the subclass relating to predefined protocols such as those for standard keyboards and mice. The invention provides for selected HDTP embodiments to include boot device protocols and one or more associated HID subclasses.

The HID class driver, depicted earlier in FIG. 34 (and executing on the host computer or other device) comprises a parser that is used to process the “Items” comprised within the Report Descriptor. FIG. 38c (adapted from Universal Serial Bus (USB) Device Class Definition for Human Interface Devices (HID) Version 1.11) depicts how an HID class device appears to this parser within the HID driver.

As shown in FIG. 38d (adapted from Universal Serial Bus (USB) Device Class Definition for Human Interface Devices (HID) Version 1.11) an HID class driver communicates with an HID class device using either host-polled communications via a “Control Pipe” formalism (the typically used approach) or an optional lower-latency (since there is no wait for a polling event from the host) asynchronous “Interrupt Pipe.” At minimum, a particular Control Pipe” (Endpoint 0) is always implemented and this can be used for carrying interrupt information from the peripheral device should the optional Interrupt Pipe be implemented. The invention provides for selected HDTP embodiments to include at least host-polled communications via the “Control Pipe” formalism. The invention provides for selected HDTP embodiments to include lower-latency asynchronous communications via the “Interrupt Pipe” formalism.

As described earlier in conjunction with FIGS. 18, 19, 22a-22c, 25, 26, and 27a-27d, various embodiments of the HDTP can process both single-finger and multi-touch tactile input from human users, and from either can produce both real-time streams of (“continuous-range”) touch parameters (including (a) left-right geometric center, forward-back geometric center, downward pressure, yaw angle, roll angle, and pitch angle for individual fingers and constellations of fingers, plus (b) up to three additional “continuous-range” touch parameters for each additional finger in a multiple-finger constellations of finger) as well as real-time streams of events (threshold detections, other recognized symbols, gestures, and recognized or processed phrases). FIG. 39a depicts a summary representation of the single-finger gesture recognition and associated parameter production capabilities provided for by the invention. For example, a finger flick (taught in, for example, U.S. Pat. No. 6,570,078 and pending U.S. patent application Ser. No. 12/418,605) can be recognized as a gesture creating an event with associated symbol, and in embodiments this gesture can be provided along with associated parameters (such as velocity/acceleration, starting position, ending position, etc.). Similarly, FIG. 39b depicts a summary representation of the multi-finger constellation gesture recognition and associated parameter production capabilities provided for by the invention, for example producing real-time streams of events and real-time streams of (“continuous-range”) touch parameter(s) (including (a) left-right geometric center, forward-back geometric center, downward pressure, yaw angle, roll angle, and pitch angle for individual fingers and constellations of fingers, plus (b) up to three additional “continuous-range” touch parameters for each additional finger in a multiple-finger constellations of finger) as taught earlier in conjunction with FIGS. 19, 22a-22c, 25, 26, and 27c.

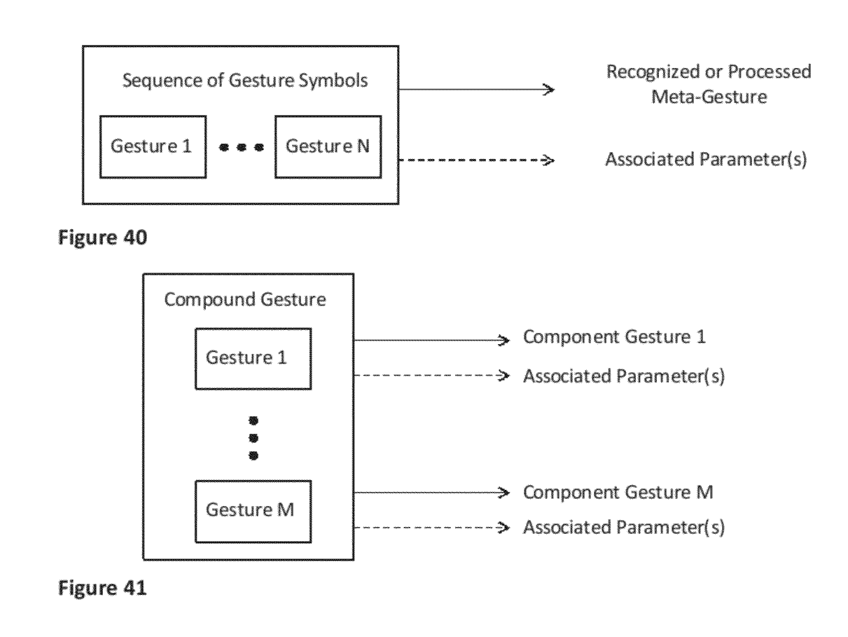

As taught earlier in conjunction with FIGS. 26 and 27a-27d, sequences of gestures can be recognized or processed as gesture phrases. These gesture phrases, which could be treated as gestures themselves and thus viewed as “meta-gestures,” can also comprise events and associated parameter(s). FIG. 40 depicts a summary representation of the gesture-sequence recognition/processing and associated parameter production capabilities provided for by the invention.

Additionally, as taught in U.S. Pat. No. 6,570,078, embodiments of the HDTP can recognize and provide rich metaphor capabilities and other arrangements which involve combinations of two or more independent simultaneous gestures. In some cases the two or more independent simultaneous gestures may be rendered with separate fingers (for example as taught in conjunction with FIGS. 22a-22c), but in other cases the two or more independent simultaneous gestures may be rendered with the same finger. An example of this, taught in U.S. Pat. No. 6,570,078, involves associating one parameter pair (left/right and forward/backward “position”) and another parameter pair (roll and pitch) as two independent planes. In this example there is available potential added structure for rich metaphors in regarding the roll/pitch (angle) plane as being superimposed over the position (left/right and forward/backward) plane. The superposition aspect of the metaphor can be used in an input-plane/output-plane distinction for a two-input/two-output transformation, as two separated processes which may be caused to converge or morph according to additional overall pressure, in conjunction with a dihedral angle of intersection between two independent processes, etc. FIG. 41 depicts a summary representation of the compound gesture recognition/processing and associated parameter production capabilities provided for by the invention.

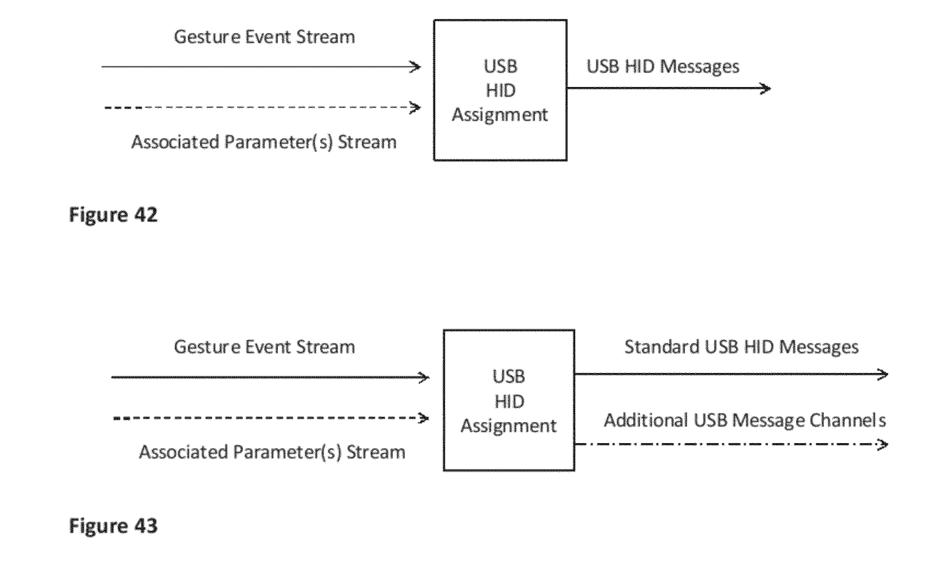

The capabilities described in conjunction with FIGS. 39a-39b, 40, and 41, in addition to those described elsewhere, show that many possible embodiments of the HDTP will comprise real-time gesture event (comprising symbols) and possible associated parameter streams whose types of information and number of simultaneous channels can vary radically over time. In particular, in many possible embodiments of the HDTP the number of simultaneous channels can vary over wide range, and the context to which various gesture symbol and associated parameter streams are assigned roles in applications can also vary over wide range. To be carried via USB using the HID class, each of these potential channels and symbols must be assigned to USB HID messages. Accordingly the invention provides for selected HDTP embodiments to include mapping of a gesture event (symbol) stream and possible associated parameter(s) stream to corresponding USB HID messages. FIG. 42 depicts a representation illustrating the mapping of a gesture event (symbol) stream and possible associated parameter(s) stream to corresponding USB HID messages.

Further, the USB HID messages associated with some embodiments of the HDTP can comprise “standard” or “pseudo-standard” types of USB messages and/or other types of USB message channels. For example, in some embodiments, the HDTP can use standard messages used for mouse and/or keyboard (as described a few paragraphs above). As another example, the HDTP can use (more loosely) standardized messages used for the existing multi-axis game controller HID report descriptors and profiles. As another example, the HDTP can use the arrangement and messages employed by the Logitech 3DConnexion SpaceNavigator™ as a pseudo-standard. This allows the HDTP to operate the large number of commercial 3D software applications already supporting the Logitech 3DConnexion SpaceNavigator™ (see for example the list at http://www.3dconnexion.com/supported-software/software0.html, visited Jan. 22, 2011) so as to provide the HDTP's highly-improved user experience, ease-of-use, rich metaphors, and superior precision-control performance to those commercial 3D software applications.

As an example of merely one of the many possibilities, FIG. 43 depicts a representation illustrating an example mapping of a gesture event (symbol) stream and possible associated parameter(s) stream to corresponding “Standard” USB HID messages and additional USB HID messages.

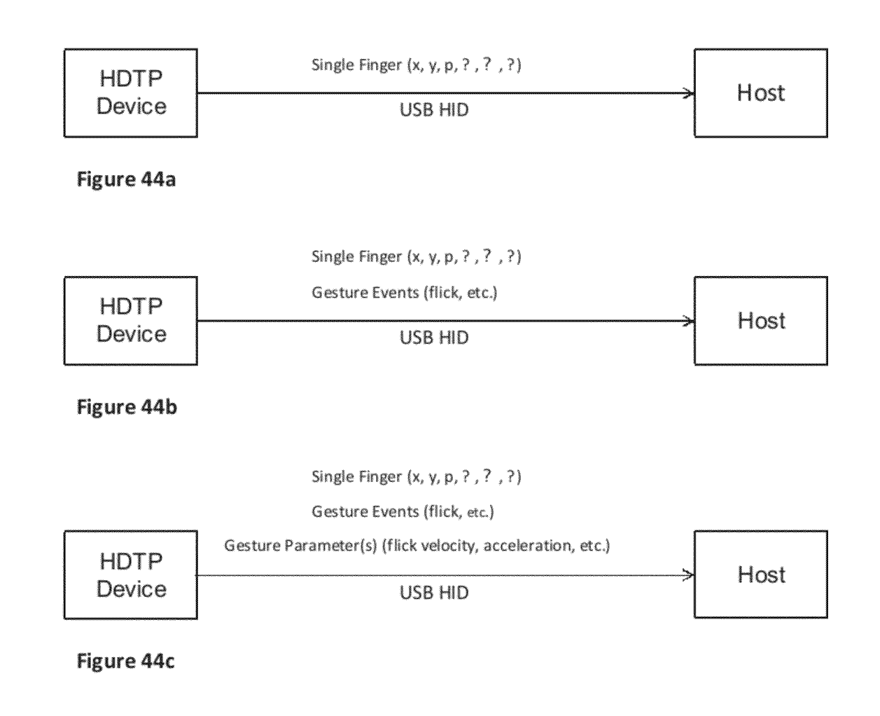

FIG. 44a depicts the single-finger parameter channel arrangements depicted in FIGS. 39a, 42, and 43 mapped on to the arrangement depicted in FIG. 37.

FIG. 44b depicts the single-finger parameter and gesture event arrangements depicted in FIGS. 39a, 42, and 43 mapped on to the arrangement depicted in FIG. 37.

FIG. 44c depicts the single-finger parameter, gesture event, and associated gesture parameter arrangements depicted in FIGS. 39a, 42, and 43 mapped on to the arrangement depicted in FIG. 37.

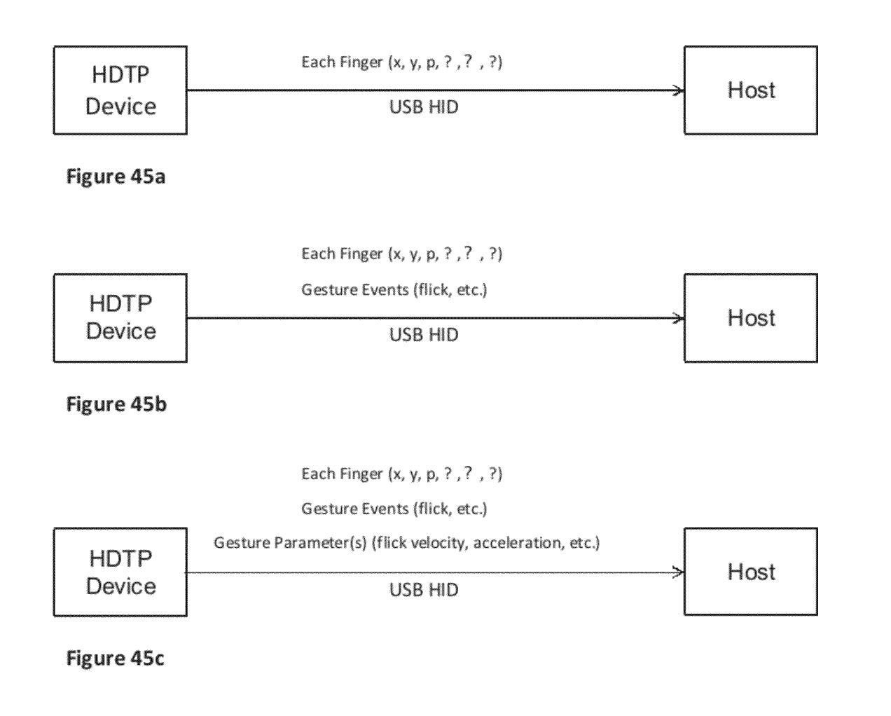

FIG. 45a depicts the multi-finger parameter channel arrangements depicted in FIGS. 39b, 42, and 43 mapped on to the arrangement depicted in FIG. 37.

FIG. 45b depicts the multi-finger parameter and gesture event arrangements depicted in FIGS. 39b, 42, and 43 mapped on to the arrangement depicted in FIG. 37.

FIG. 45c depicts the multi-finger parameter, gesture event, and associated gesture parameter arrangements depicted in FIGS. 39b, 42, and 43 mapped on to the arrangement depicted in FIG. 37.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

While the invention has been described in detail with reference to disclosed embodiments, various modifications within the scope of the invention will be apparent to those of ordinary skill in this technological field. It is to be appreciated that features described with respect to one embodiment typically can be applied to other embodiments.

The invention can be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

Although exemplary embodiments have been provided in detail, various changes, substitutions and alternations could be made thereto without departing from spirit and scope of the disclosed subject matter as defined by the appended claims. Variations described for the embodiments may be realized in any combination desirable for each particular application. Thus particular limitations and embodiment enhancements described herein, which may have particular advantages to a particular application, need not be used for all applications. Also, not all limitations need be implemented in methods, systems, and apparatuses including one or more concepts described with relation to the provided embodiments. Therefore, the invention properly is to be construed with reference to the claims.

I claim:

1. A method for implementing USB communications providing user interface measurement and detection of at least one gesture and one angle of finger position for a touch-based user interface, the method comprising:
receiving real-time tactile-image information from a tactile sensor array;
processing the real-time tactile-image information to detect and measure the variation of one angle of a finger position and to detect at least one gesture, the processing further producing at least one of a parameter value responsive to the variation in the finger angle and a symbol responsive to a detected gesture;
mapping the at least one parameter value and symbol to a Universal Serial Bus (USB) Human Interface Device (HID) message, and
transmitting the HID message to a host device over USB hardware,
wherein the at least one parameter value and symbol is carried by the USB HID message for use by an application executing on the host device.

2. The method of claim 1 wherein the host device comprises a computer.

3. The method of claim 1 wherein the tactile sensor array comprises a touchscreen.

4. The method of claim 1 wherein the finger angle comprises a yaw angle.

5. The method of claim 1 wherein the finger angle comprises a roll angle.

6. The method of claim 1 wherein the finger angle comprises a pitch angle.

7. The method of claim 1 wherein the gesture comprises a finger flick.

8. The method of claim 1 wherein the processing also produces at least one gesture parameter, the gesture parameter comprising a value responsive to the real-time tactile-image information.

9. The method of claim 8 wherein the at least one gesture parameter is carried by the USB HID message.

10. The method of claim 1 wherein at least one of the processing, mapping, and transmitting comprises a HID Report Descriptor.

11. The method of claim 10 wherein the HID Report Descriptor is transmitted to the host device.

12. The method of claim 1 wherein at least one of the processing, mapping, and transmitting comprises at least one HID Physical Descriptor.

13. The method of claim 1 wherein at least one of the processing, mapping, and transmitting comprises at least one HID Endpoint Descriptor.

14. The method of claim 1 wherein at least one of the processing, mapping, and transmitting comprises at least one HID Configuration Descriptor.

15. The method of claim 1 wherein the processing further recognizes a plurality of gestures.

16. The method of claim 15 wherein the processing of selected gestures within the plurality of gestures also produces at least one parameter associated with each selected gesture responsive to real-time tactile-image information.

17. The method of claim 16 wherein the value of at least one parameter associated with each selected gesture is carried by the USB HID message.

18. The method of claim 15 wherein a sequence of gestures is presented further processing to create a meta-gesture.

19. The method of claim 17 wherein the further processing employs a tactile grammar.

20. The method of claim 17 wherein information representing the meta-gesture is carried by the USB HID message.
